(19) United States
(12) Patent Application Publication
(10) Pub. No.: US 2026/0173065 A1
(43) Pub. Date: Jun. 18, 2026

(54) MULTI-PART UPLINK TRANSMISSION

(71) Applicant: InterDigital Patent Holdings, Inc., Wilmington, DE (US)

(72) Inventors: Tuong Duc Hoang, Montreal (CA); Ghyslain Pelletier, Montreal (CA); Faris Alfarhan, Montreal (CA); Paul Marinier, Brossard (CA)

(73) Assignee: InterDigital Patent Holdings, Inc., Wilmington, DE (US)

(21) Appl. No.: 18/985,966

(22) Filed: Dec. 18, 2024

(51) Int. Cl. H04W 72/12; H04B 7/06; H04L 1/00; H04L 1/1812; H04L 5/00; H04W 52/36; H04W 72/21; H04W 76/20

(52) U.S. Cl. CPC H04W 72/12; H04B 7/0626; H04L 1/0003; H04L 1/1812; H04L 5/0051; H04W 52/367; H04W 72/21; H04W 76/20

(57) ABSTRACT

Systems, methods, and instrumentalities are disclosed herein for a multi-part uplink transmission. A wireless transmit/receive unit (WTRU) may receive configuration information. The WTRU may determine at least a first set of units to be transmitted in the second part of the multi-part transmission, a second set of units to be transmitted in a third part of the multi-part transmission, at least one transmission parameter associated with the second part or at least one transmission parameter associated with the third part of the multi-part transmission. The WTRU may indicate the at least one transmission parameter associated with the second part of the multi-part transmission in the first part of the multi-part transmission. The WTRU may multiplex at least one of the first set of units in a first transport block (TB) or the second set of units in a second TB. The WTRU may perform the multi-part transmission.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed herein for a multi-part uplink transmission. For example, a device, such as a wireless transmit/receive unit (WTRU), may include a processor, transceiver, and/or memory. The processor, transceiver, and/or memory may be configured to perform one or more of the following.

The WTRU may receive configuration information. The configuration information may be, or may include, at least one of: a multi-part resource for a multi-part transmission, at least one set of units associated with the multi-part transmission, or information associated with the at least one set of units. The multi-part transmission may include at least a first part, a second part, and/or the like. In examples, the multi-part transmission may include two parts: a first part and a second part. In examples, the multi-part transmission may include three parts: a first part, a second part, and a third part. In examples, the multi-part transmission may include more than three part transmissions.

The multi-part resource for the multi-part transmission may be associated with a scheduled resource for the multi-part transmission. The at least one set of units may be associated with at least one of the second part of the multi-part transmission or the third part of the multi-part transmission. The information associated with the at least one set of units may be, or may include, at least one of format information for the at least one set of units or size information associated with the at least one set of units.

The at least one set of units described herein may be, or may include, one or more of the following: a control unit, a data unit, a control and data unit, a service data unit (SDU) associated with a protocol layer, a protocol data unit (PDU) associated with a protocol layer, a subset of a PDU set, a PDU set, a multi interdependent PDU sets, or a data burst.

The WTRU may receive a multi-part grant associated with the multi-part transmission. As described herein, the multi-part transmission may be, or may include, at least two parts (e.g., at least a first part and a second part). In examples, the multi-part transmission may be associated with an uplink transmission. For example, the multi-part transmission may be an uplink transmission.

The WTRU may determine that data is available. For example, the WTRU may determine that data is available for the multi-part transmission.

Based on the configuration information and the determination that data is available, the WTRU may determine at least a first set of units to be transmitted in the second part of the multi-part transmission, a second set of units to be transmitted in a third part of the multi-part transmission, at least one transmission parameter associated with the second part of the multi-part transmission, and/or at least one transmission parameter associated with the third part of the multi-part transmission.

In examples, the at least one transmission parameter associated with the second part of the multi-part transmission and the at least one transmission parameter associated with the third part of the multi-part transmission may be, or may include, one or more of the following: a modulation and/or coding (MCS), a resource size, or a number of bits in a bit-sequence to transmit the second part of the multi-part transmission, a channel format, a demodulation reference signal (DMRS) pattern, a relative transmission power, an applicable transmission power offset, an applicable maximum power reduction (MPR), an applicable set of power control parameters, an applicable transmission configuration indicator (TCI) state, or a beam associated with the second part of the multi-part transmission.

In examples, the WTRU may determine the at least one transmission parameter associated with the second part of the multi-part transmission based on a quality of service (QoS) associated with the first set of units. In examples, the WTRU may determine the at least one transmission parameter associated with the third part of the multi-part transmission based on a QoS associated with the second set of units.

The WTRU may indicate the at least one transmission parameter associated with the second part of the multi-part transmission in the first part of the multi-part transmission or the at least one transmission parameter associated with the third part of the multi-part transmission in the first part of the multi-part transmission. For example, the WTRU may determine at least one transmission parameter associated with the second part of the multi-part transmission in the first part of the multi-part transmission or the at least one transmission parameter associated with the third part of the multi-part transmission in the first part of the multi-part transmission. As described herein, the WTRU may perform the multi-part transmission that includes the determined at least one transmission parameter associated with the second part of the multi-part transmission in the first part of the multi-part transmission or the at least one transmission parameter associated with the third part of the multi-part transmission in the first part of the multi-part transmission.

In examples, the first part of the multi-part transmission may be associated with a transmission of an uplink control information (UCI) format to indicate transmission information associated with at least one of the second part or the third part of the multi-part transmission.

The WTRU may multiplex at least one of the first set of units in a first transport block (TB) or the second set of units in a second TB, wherein the first TB is to be transmitted in the second part of the multi-part transmission, and wherein the second TB is to be transmitted in the third part of the multi-part transmission.

The first TB may be associated with a transmission of a medium access control (MAC) control element (CE). For example, the MAC-CE may be, or may include, at least one of hybrid automatic repeat request (HARQ) Acknowledgement (ACK), HARQ Negative ACK (NACK), or Channel State Information (CSI) reporting. For example, the second TB may be associated with a data transmission (e.g., data from a higher layer) and/or MAC-CE.

The WTRU may perform the multi-part transmission associated with the multi-part grant. For example, the WTRU may transmit at least one of the first TB that is associated with the second part of the multi-part transmission or the second TB that is associated with the third part of the multi-part transmission. The WTRU may also transmit the first part of the multi-part transmission.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a WTRU using a first part of a multi-part transmission to indicate transmission information about the second part of the multi-part transmission.

FIG. 3 illustrates an example flow diagram illustrating the WTRU using the first part to indicate the transmission information about the second part.

FIGS. 4A-C illustrate examples of the multiplexing between the first and the second part for a two-part resource. FIG. 4A illustrates an example of the WTRU being configured to perform multiplexing and a transmission using a two-part resource, in which the first part and the second part may be multiplexed using frequency division multiplexing (FDM). FIG. 4B illustrates an example of the WTRU being configured to perform multiplexing and a transmission using a two-part resource, in which the first part and the second part may be multiplexed using time division multiplexing (TDM). FIG. 4C illustrates an example of the WTRU being configured to perform multiplexing and a transmission using a two-part resource, in which the first part and the second part may be multiplexed using FDM and TDM.

FIG. 5 illustrates an example of a WTRU performing Physical Layer (PHY) duplications for a medium access control (MAC) control element (CE) in a multi-part resource.

FIG. 6 illustrates an example of a WTRU performing sequential multiplexing of control/data units in multi-part resource.

### DETAILED DESCRIPTION

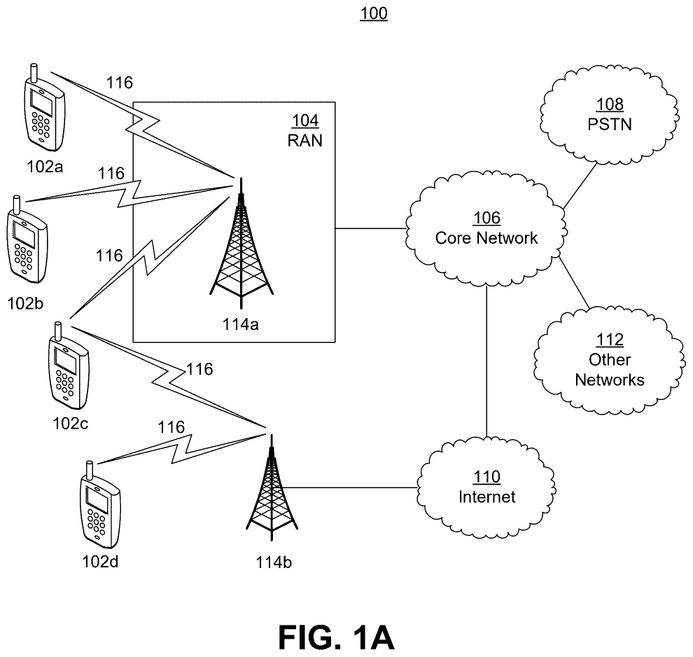

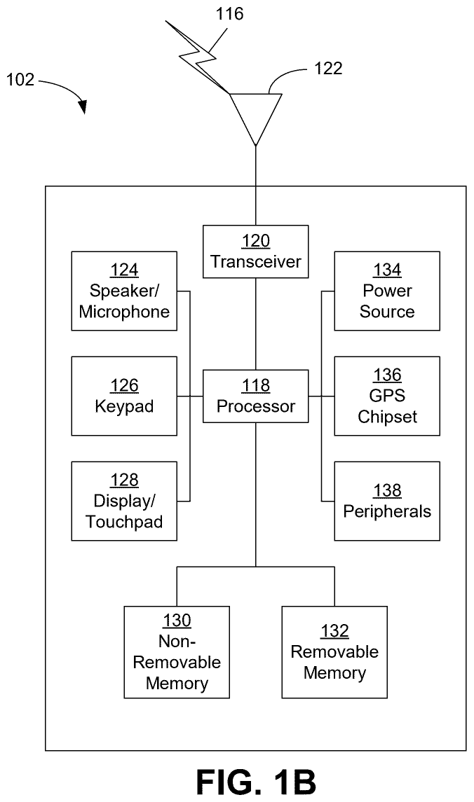

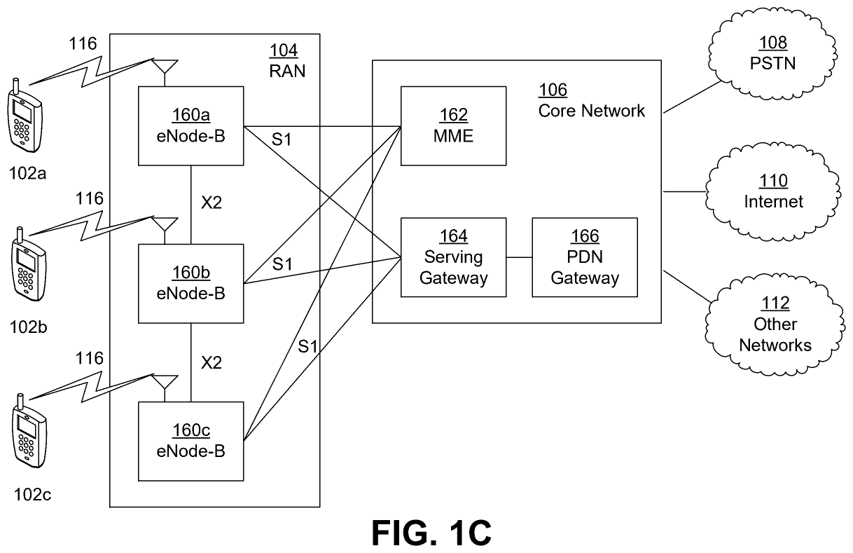

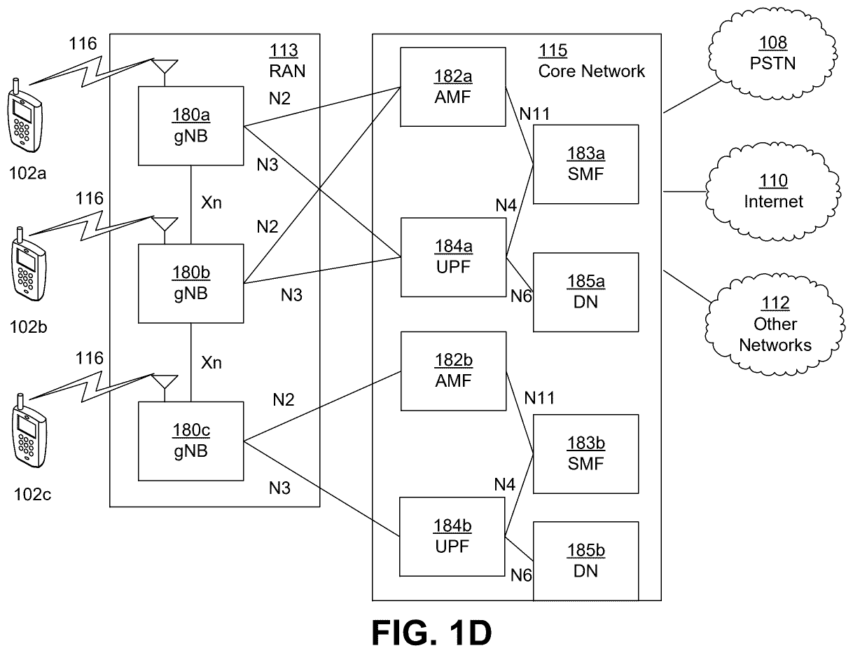

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA,” may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are disclosed herein for a multi-part uplink transmission. For example, a device, such as a wireless transmit/receive unit (WTRU), may include a processor, transceiver, and/or memory. The processor, transceiver, and/or memory may be configured to perform one or more of the following.

The WTRU may receive configuration information. The configuration information may be, or may include, at least one of: a multi-part resource for a multi-part transmission, at least one set of units associated with the multi-part transmission, or information associated with the at least one set of units. The multi-part transmission may include at least a first part, a second part, and/or the like. In examples, the multi-part transmission may include two parts: a first part and a second part. In examples, the multi-part transmission may include three parts: a first part, a second part, and a third part. In examples, the multi-part transmission may include more than three part transmissions.

The multi-part resource for the multi-part transmission may be associated with a scheduled resource for the multi-part transmission. The at least one set of units may be associated with at least one of the second part of the multi-part transmission or the third part of the multi-part transmission. The information associated with the at least one set of units may be, or may include, at least one of format information for the at least one set of units or size information associated with the at least one set of units.

The at least one set of units described herein may be, or may include, one or more of the following: a control unit, a data unit, a control and data unit, a service data unit (SDU) associated with a protocol layer, a protocol data unit (PDU) associated with a protocol layer, a subset of a PDU set, a PDU set, a multi interdependent PDU set, or a data burst.

The WTRU may receive a multi-part grant associated with the multi-part transmission. As described herein, the multi-part transmission may be, or may include, at least two parts (e.g., at least a first part and a second part). In examples, the multi-part transmission may be associated with an uplink transmission. For example, the multi-part transmission may be an uplink transmission.

The WTRU may determine that data is available. For example, the WTRU may determine that data is available for the multi-part transmission.

Based on the configuration information and the determination that data is available, the WTRU may determine at least a first set of units to be transmitted in the second part of the multi-part transmission, a second set of units to be transmitted in a third part of the multi-part transmission, at least one transmission parameter associated with the second part of the multi-part transmission, and/or at least one transmission parameter associated with the third part of the multi-part transmission.

In examples, the at least one transmission parameter associated with the second part of the multi-part transmission and the at least one transmission parameter associated with the third part of the multi-part transmission may be, or may include, one or more of the following: a modulation and/or coding (MCS), a resource size, or a number of bits in a bit-sequence to transmit the second part of the multi-part transmission, a channel format, a demodulation reference signal (DMRS) pattern, a relative transmission power, an applicable transmission power offset, an applicable maximum power reduction (MPR), an applicable set of power control parameters, an applicable transmission configuration indicator (TCI) state, or a beam associated with the second part of the multi-part transmission.

In examples, the WTRU may determine the at least one transmission parameter associated with the second part of the multi-part transmission based on a quality of service (QoS) associated with the first set of units. In examples, the WTRU may determine the at least one transmission parameter associated with the third part of the multi-part transmission based on a QoS associated with the second set of units.

The WTRU may indicate the at least one transmission parameter associated with the second part of the multi-part transmission in the first part of the multi-part transmission or the at least one transmission parameter associated with the third part of the multi-part transmission in the first part of the multi-part transmission. For example, the WTRU may determine at least one transmission parameter associated with the second part of the multi-part transmission in the first part of the multi-part transmission or the at least one transmission parameter associated with the third part of the multi-part transmission in the first part of the multi-part transmission. As described herein, the WTRU may perform the multi-part transmission that includes the determined at least one transmission parameter associated with the second part of the multi-part transmission in the first part of the multi-part transmission or the at least one transmission parameter associated with the third part of the multi-part transmission in the first part of the multi-part transmission.

In examples, the first part of the multi-part transmission may be associated with a transmission of an uplink control information (UCI) format to indicate transmission information associated with at least one of the second part or the third part of the multi-part transmission.

The WTRU may multiplex at least one of the first set of units in a first transport block (TB) or the second set of units in a second TB, wherein the first TB is to be transmitted in the second part of the multi-part transmission, and wherein the second TB is to be transmitted in the third part of the multi-part transmission.

The first TB may be associated with a transmission of a medium access control (MAC) control element (CE). For example, the MAC-CE may be, or may include, at least one of hybrid automatic repeat request (HARQ) Acknowledgement (ACK), HARQ Negative ACK (NACK), or Channel State Information (CSI) reporting. The second TB may be associated with a data transmission (e.g., data associated with prior transmission).

The WTRU may perform the multi-part transmission associated with the multi-part grant. For example, the WTRU may transmit at least one of the first TB that is associated with the second part of the multi-part transmission or the second TB that is associated with the third part of the multi-part transmission. The WTRU may also transmit the first part of the multi-part transmission.

Data treatment may be configured, e.g., in 5G. In examples, the configured data treatment may be, or may include, one or more of data multiplexing in a scheduled grant or uplink control information (UCI) piggyback Physical Uplink Shared Channel (PUSCH).

Data may be multiplexed in a scheduled grant. In a system (e.g., in the current 5G new radio (NR) system), a WTRU may be scheduled with uplink transmission resource for data transmission, e.g., via configured grant and/or dynamic grant. Upon the availability of a scheduled grant, the WTRU may start (e.g., then start) the Logical Channel Prioritization (LCP) procedure to multiplex the control/data to a transport block (TB) for transmission in the scheduled grant. For transmission of the TB, the WTRU may use a (e.g., one) set of transmission parameters (e.g., transmission power, transmission beam, modulation and/or coding (MCS), number of repetitions, and/or the like) for the TB (e.g., the entire TB) without differentiated treatment for different quality of service (QoS) control/data multiplexed in the TB. One or more (e.g., all) the control/data units multiplexed in the TB may achieve the same reliability and latency performance.

UCI may piggyback PUSCH. In some examples (e.g., a normal case), layer 2 (L2) control and UP data may be transmitted in PUSCH and UCI may be transmitted in Physical Uplink Control Channel (PUCCH). In some examples, PUCCH may achieve higher reliability (e.g., much higher reliability) compared to PUSCH as it uses one or more conservative transmission parameters, such as modulation and coding scheme (MCS) and Demodulation Reference Signal (DMRS) pattern. An exemplary system (e.g., a 5G system) may allow the WTRU to piggyback UCI in PUSCH if (e.g., when) PUCCH and PUSCH are overlapping. This mechanism may enable the WTRU to transmit (e.g., simultaneously transmit) both UCI and TB. Otherwise, the WTRU may need to drop one of the two transmissions (e.g., PUSCH or PUCCH). If (e.g., when) UCI is piggybacked in PUSCH, the WTRU may be indicated/configured by a network, the amount of resource used for UCI transmission. The same modulation may be used for UCI and/or TB. Moreover, this mechanism may be applicable if (e.g., when) the network is aware of exactly which UCI bits are conveyed to the network. Otherwise, if the UCI bit size is unknown, the network may fail to decode the bit sequence. This restriction may be feasible, as in the current system, the network is aware of which UCI bits may be transmitted by the WTRU at a certain time.

One or more requirements for future generation networks (e.g., 6G network) may be considered. For example, data in 6G networks may include (e.g., consist of) system data, e.g., channel state information or other types of control information, user plane data (e.g., web browsing, video, voice, immersive data (e.g., extended reality (XR)), or control plane data, e.g., access stratum (AS) or non-access stratum (NAS) signaling. For example, one or more of the following QoS requirements may be considered: low latency and very high reliability (e.g., data may be needed timely, e.g., for radio resource management (RRM)/link adaptation, or at the application layer); low latency but reliability may be preferred over absolute timeliness (e.g., data may be needed even if delayed, such as for slower scheduling adaptations, for data collection (e.g., system or application data), or for error concealment/recovery at the application layer); and/or other data based on different QoS requirements.

In some systems (e.g., the current 5G NR system), if (e.g., when) a TB is constructed and transmitted in PUSCH, one or more (e.g., all) control/data units in the TB may be treated equally regardless of the QoS and/or importance of the control/data unit. However, it may be desirable to differentiate certain data unit(s) (e.g., MAC-CE, high-importance service data units (SDUs), etc.) in terms of reliability, residual bit errors, and possibly even in terms of certain latency aspects.

Some control information (e.g., some control information in 6G) may benefit from being handled differently (e.g., than for 5G). For example, some control information in 6G may be handled differently than for 5G, where those may typically be reported in PUCCH such as Hybrid Automatic Repeat Request (HARQ) Acknowledgement (ACK)/Negative ACK (NACK) and/or Channel State Information (CSI) report. In some examples, other signaling may be used. For example, other signaling, such as layer 2 signaling and/or MAC-CE, may be used to convey such information. Such MAC-CE may need (e.g., then require) differentiated treatment, if (e.g., especially when) conveying data that may be more critical, e.g., to system operation, such that it may be well protected compared to other control/data units.

A treatment for certain (e.g., important) control/data units may be configured and/or configured, e.g., to increase the reliability of such control/data units. The reliability of a control/data unit may be improved by using more conservative transmission parameters, such as using a small MCS, denser DMRS, or larger transmission bandwidth. With the current design, one or more (e.g., all) the control/data units multiplexed in a transmission may have the same treatment and achieve the same reliability and/or latency performance.

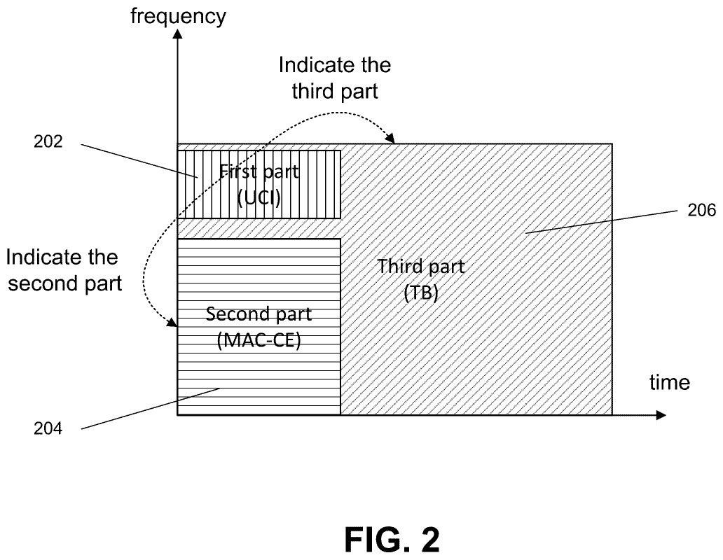

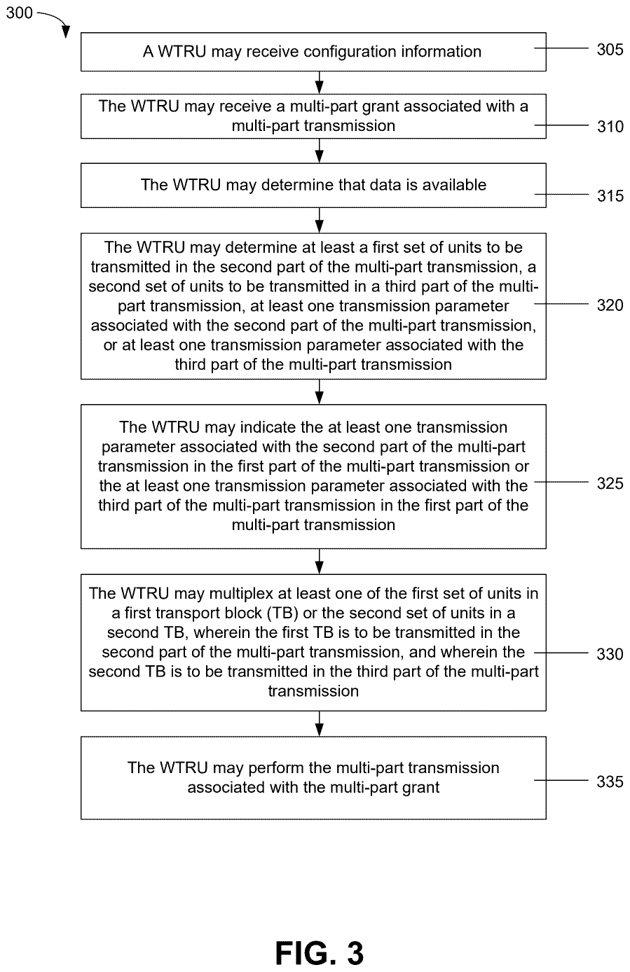

FIG. 2 illustrates an example of a WTRU using a first part of a multi-part transmission to indicate transmission information about the second part of the multi-part transmission. FIG. 3 illustrates an example flow diagram (300) illustrating the WTRU using the first part to indicate the transmission information about the second part, where one or more of the illustrated actions may be performed.

As described herein, systems, methods, and instrumentalities may be disclosed herein for how to multiplex and/or transmit different control/data units that may benefit from differentiated treatment, including units associated with different QoS to satisfy the transmission requirements associated with each control/data unit.

In examples, the WTRU may determine a resource allocation for the transmission of information that enables differentiated treatment, for example, from a configuration and/or upon receiving a multi-part grant that may allow (e.g., provide configuration(s) for) the WTRU to use: the first part (e.g., the first part of a multi-part transmission) to indicate information about the second part (e.g., the second part of the multi-part transmission), multiplex the units (e.g., the control/data units described herein) associated with the second part, determine one or more transmission parameters (e.g., the resource size, the MCS, and/or the like) based on the transmission requirements (e.g., QoS) of the multiplexed control/data multiplexed in the second part, and/or indicate the determined transmission parameters in the first part.

The WTRU may receive configuration(s) (e.g., may receive configuration information). For example, as illustrated in 305 of FIG. 3, the WTRU may receive a configuration. In examples, the WTRU may receive the resource for multi-part transmission (e.g., the first part and/or the second part) associated with a scheduled resource for data transmission (e.g., PUSCH). In examples, the WTRU may receive the set of control/data units (e.g., MAC-CE for HARQ feedback, CSI report, high-importance/priority data, and/or the like) that may be transmitted in the second part. In examples, the WTRU may receive the possible format(s)/size(s) of the control/data units to be transmitted in the second part.

In examples, the WTRU may receive configuration information. The configuration information may be, or may include or indicate, at least one of: a multi-part resource for a multi-part transmission, at least one set of units associated with the multi-part transmission, or information associated with the at least one set of units. The multi-part transmission may include at least a first part, a second part, and/or the like. In examples, the multi-part transmission may include two parts: a first part and a second part. In examples, the multi-part transmission may include three parts: a first part, a second part, and a third part. In examples, the multi-part transmission may include more than three part transmissions.

In examples described herein, the multi-part resource for the multi-part transmission may be associated with a scheduled resource for the multi-part transmission. The at least one set of units may be associated with at least one of the second part of the multi-part transmission or the third part of the multi-part transmission. The information associated with the at least one set of units may be, or may include, at least one of format information for the at least one set of units or size information associated with the at least one set of units.

As described herein, the at least one set of units described herein may be, or may include, one or more of the following: a control unit, a data unit, a control and data unit, a service data unit (SDU) associated with a protocol layer, a protocol data unit (PDU) associated with a protocol layer, a subset of a PDU set, a PDU set, a multi interdependent PDU set, or a data burst.

The WTRU may receive a multi-part (e.g., three-part) grant for uplink transmission, which may allow the WTRU to transmit the first, the second, and the third part.

In examples, as illustrated in 310 of FIG. 3, the WTRU may receive a multi-part grant associated with the multi-part transmission. As described herein, the multi-part transmission may be, or may include, at least two parts (e.g., at least a first part and a second part). In examples, the multi-part transmission may be associated with an uplink transmission. For example, the multi-part transmission may be an uplink transmission.

As described herein and as illustrated in FIG. 2, the WTRU may perform the multi-part transmission. The multi-part transmission may be, or may include, a first part (202), a second part (204), and/or a third part (206).

As illustrated in 315 of FIG. 3, the WTRU may determine that data is available. For example, the WTRU may determine that data is available for the multi-part transmission.

In examples, as illustrated in 320 of FIG. 3, based on the configuration information and the determination that data is available, the WTRU may determine at least a first set of units to be transmitted in the second part of the multi-part transmission, a second set of units to be transmitted in a third part of the multi-part transmission, at least one transmission parameter associated with the second part of the multi-part transmission, and/or at least one transmission parameter associated with the third part of the multi-part transmission.

In examples, the at least one transmission parameter associated with the second part of the multi-part transmission and the at least one transmission parameter associated with the third part of the multi-part transmission may be, or may include, one or more of the following: a modulation and/or coding (MCS), a resource size, or a number of bits in a bit-sequence to transmit the second part of the multi-part transmission, a channel format, a demodulation reference signal (DMRS) pattern, a relative transmission power, an applicable transmission power offset, an applicable maximum power reduction (MPR), an applicable set of power control parameters, an applicable transmission configuration indicator (TCI) state, or a beam associated with the second part of the multi-part transmission.

The WTRU may determine one or more of the following: the set of associated control/data units to transmit in the second part; and/or the transmission parameters associated with the second part (e.g., MCS, size, and/or the like) based on the QoS of the control/data unit.

In examples, the WTRU may determine the at least one transmission parameter associated with the second part of the multi-part transmission based on a quality of service (QoS) associated with the first set of units. In examples, the WTRU may determine the at least one transmission parameter associated with the third part of the multi-part transmission based on a QoS associated with the second set of units.

The WTRU may indicate the transmission parameters (e.g., the availability of the second part, the MCS, the resource size, and/or the like) of the second part in the first part.

As illustrated in 325 of FIG. 3, the WTRU may indicate the at least one transmission parameter associated with the second part of the multi-part transmission in the first part of the multi-part transmission or the at least one transmission parameter associated with the third part of the multi-part transmission in the first part of the multi-part transmission. For example, the WTRU may determine and/or indicate at least one transmission parameter associated with the second part of the multi-part transmission in the first part of the multi-part transmission or the at least one transmission parameter associated with the third part of the multi-part transmission in the first part of the multi-part transmission. As described herein, the WTRU may perform the multi-part transmission that includes the determined at least one transmission parameter associated with the second part of the multi-part transmission in the first part of the multi-part transmission and/or the at least one transmission parameter associated with the third part of the multi-part transmission in the first part of the multi-part transmission.

In examples, the first part of the multi-part transmission may be associated with a transmission of an uplink control information (UCI) format to indicate transmission information associated with at least one of the second part or the third part of the multi-part transmission.

The WTRU may multiplex the control/data units in a TB to be transmitted in the third part.

In examples, as illustrated in 330 of FIG. 3, the WTRU may multiplex at least one of the first set of units in a first transport block (TB) or the second set of units in a second TB, wherein the first TB is to be transmitted in the second part of the multi-part transmission, and wherein the second TB is to be transmitted in the third part of the multi-part transmission.

In examples, the multi-part transmission may be associated with multiple TBs. For example, as described herein, the first TB and the second TB associated with the multi-part transmission may be separate (e.g., different TBs). In examples, the multi-part transmission may be associated with a TB (e.g., one TB). For example, as described herein, the first TB and the second TB may be (e.g., may each be) sub-TBs associated with a TB (e.g., one TB). The sub-TBs may be (e.g., may also be) associated with sub-PDUs.

The first TB may be associated with a transmission of a medium access control (MAC) control element (CE). For example, the MAC-CE may be, or may include, at least one of hybrid automatic repeat request (HARQ) Acknowledgement (ACK), HARQ Negative ACK (NACK), or Channel State Information (CSI) reporting. The second TB may be associated with a data transmission (e.g., data associated with prior transmission).

The WTRU may transmit the TB and/or the determined first part and second part in the scheduled grant.

In examples, as illustrated in 335 of FIG. 3, the WTRU may perform the multi-part transmission associated with the multi-part grant. For example, the WTRU may transmit at least one of the first TB that is associated with (e.g., indicates information about) the second part of the multi-part transmission or the second TB that is associated with (e.g., indicates information about) the third part of the multi-part transmission.

As described herein, FIG. 2 illustrates an example of the WTRU using the first part to indicate the transmission information about the second part as described herein. For example, as illustrated in FIG. 2, the WTRU may use the first part (202) to indicate the transmission information about the second part (204).

In examples, the multi-part transmission may be associated with multiple TBs. For example, as described herein, the first TB and the second TB associated with the multi-part transmission may be separate (e.g., different TBs). In examples, the multi-part transmission may be associated with a TB (e.g., one TB). For example, as described herein, the first TB and the second TB may be (e.g., may each be) sub-TBs associated with a TB (e.g., one TB). The sub-TBs may be (e.g., may also be) associated with sub-PDUs.

The examples described herein (e.g., as illustrated in FIG. 2 and/or FIG. 3) may enable the WTRU to transmit (e.g., flexibly transmit) a control/data unit (e.g., an important control/data unit), such as a control/data unit (e.g., a set of control/data units) that satisfies a condition) with better protection (e.g., increased reliability compared to the TB transmitted in the grant).

As described herein, the terminology network may be used to describe (e.g., generally describe) a function that may configure, allocate, and/or control a transmission, such as a base station serving the WTRU, a gNB, a 6G gNB, a Transmission-Reception Point (TRP), a network entity such as Location Management Function (LMF), a coordinator device (e.g., a relay WTRU, another WTRU, a group coordinator, and/or the like), and/or the like.

The WTRU may transmit or receive a physical channel or reference signal according to at least one spatial domain filter. The term beam may be used to refer to a spatial domain filter.

The WTRU may transmit a physical channel or signal using the same spatial domain filter as the spatial domain filter used for receiving a Reference Signal (RS) (e.g., such as CSI-RS) or a Synchronization Signal (SS) block. The WTRU transmission may be referred to as “target,” and the received RS or SS block may be referred to as “reference” or “source.” In some examples, the WTRU may be said to transmit the target physical channel or signal, e.g., according to a spatial relation with a reference to such RS or SS block.

The WTRU may transmit a physical channel (e.g., a first physical channel) or signal, e.g., according to the same spatial domain filter as the spatial domain filter used for transmitting another physical channel (e.g., a second physical channel) or signal. The first and second transmissions may be referred to as “target” and “reference” (e.g., or “source”), respectively. In some examples, the WTRU may be said to transmit the first physical channel (e.g., target physical channel) or signal according to a spatial relation with a reference to the second physical channel (e.g., reference physical channel) or signal.

A spatial relation may be implicit, configured by Radio Resource Control (RRC), and/or signaled by a medium access control (MAC) control element (CE) or downlink control information (DCI). For example, the WTRU may transmit (e.g., implicitly transmit) PUSCH and DM-RS of PUSCH, e.g., according to the same spatial domain filter as a Sounding Reference Signal (SRS) indicated by an SRS resource indicator (SRI) indicated in DCI or configured by RRC. In some examples, a spatial relation may be configured by RRC for an SRI or signaled by MAC CE for a PUCCH. Such spatial relation may be referred to as a “beam indication.”

The WTRU may receive a first downlink channel (e.g., a target downlink channel) or signal according to the same spatial domain filter or spatial reception parameter as a second downlink channel (e.g., reference downlink channel) or signal. For example, such association may exist between a physical channel, such as PDCCH or PDSCH and its respective DM-RS. At least if (e.g., when) the first and second signals are reference signals, such an association may exist if (e.g., when) the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may be referred to as a “beam indication.” The term RS may be interchangeably used with one or more of RS resource, RS resource set, RS port, and/or RS port group. The term RS may be interchangeably used with one or more of synchronization signal blocks (SSB), CSI-RS, SRS, and/or DM-RS.

As described herein, the term “the WTRU may be configured with something” may be used to indicate that the WTRU may be preconfigured with something or the WTRU may receive configuration information (e.g., network configuration information) of something. The network configuration may be received via a System Information Broadcast (SIB), a dedicated RRC message, MAC CE, and/or DCI. For example, the WTRU may be configured with a threshold that may be equivalent to the WTRU that may be preconfigured (e.g., the WTRU may store the configuration) with the threshold, or the WTRU may receive the threshold, e.g., from the network via one or more of SIB, RRC, MAC CE, and/or DCI.

As described herein, an indication from the network and configuration from the network may be used interchangeably. Both terminologies may be used to describe the WTRU receiving the scheduling decision from the network. The WTRU may receive an indication/configuration from the network via downlink reception, such as SIB, NAS, RRC, MAC-CE, and/or DCI.

As described herein, a control/data unit may be used to represent/indicate/describe a control unit, a data unit, and a control and data unit. A control and data unit may be a unit including both a control bit and a data bit. A unit in control/data unit may be used to represent/indicate/describe one or any combination of the granularities for control/data treatment from the WTRU and the network. A (e.g., one) unit granularity may be one or any combination of the following: a (e.g., one) control/data bit; a (e.g., one) SDU (e.g., segment) in a protocol layer (e.g., Service data adaptation protocol (SDAP)/packet data convergence protocol (PDCP)/RRC/radio link control (RLC)/MAC SDU (e.g., segment), MAC-CE, TB (e.g., segment), Codeblock Group (CBG), codeblock (CB), UCI, and/or the like); a Protocol Data Unit (PDU) (e.g., segment) in a protocol layer (e.g., a SDAP/PDCP/RRC/RLC/MAC PDU-segment, and/or the like); one or more subsets of a PDU set; one or more PDU sets; multiple interdependent PDU sets (e.g., two or more PDU sets associated with each other based on a given characteristic and/or configuration aspect); and/or a data burst.

As described herein, a control unit may be used to represent/indicate/describe a control unit in a layer (e.g., NAS, SDAP, PDCP, RLC, MAC, Physical Layer (PHY), and/or the like). For example, a control unit may be associated with a control bit in a Signaling Radio Bearer (SRB) for NAS, an RRC message, a control PDCP PDU/SDU, a control RLC PDU/SDU, a MAC CE, a UCI, and/or the like.

As described herein, a data unit may be used to represent/indicate/describe a data unit from the user plane in a layer (e.g., NAS, SDAP, PDCP, RLC, MAC, PHY, and/or the like). For example, a data unit may be associated with a data bit in a QoS flow, a data bit in a DRB, a PDCP SDU/PDU, an RLC SDU/PDU, a MAC SDU/PDU, a TB (e.g., segment), a CB/CBG, and/or the like.

As described herein, QoS associated with a control/data unit may be used to indicate/describe one or more of the following: one or more parameters (e.g., QoS) of an SDU/PDU (segment) associated with the control/data unit, in which the control/data unit may belong to the SDU/PDU (segment) or the SDU/PDU (segment) may belong to the control/data unit; one or more parameters of a PDU Set (e.g., QoS parameters) associated with the control/data unit, in which the control/data unit may belong to the PDU set or the PDU set may belong to the control/data unit; one or more parameters of a Data Burst associated with the control/data unit; and/or one or more redundancy parameters (e.g., Application Layer Forward Error Correction ratio (AL-FEC ratio) associated with the control/data unit, which may be used to indicate the number of required PDUs to decode the PDU set and/or the maximum bit error rate (BER)/Block Error Rate (BLER) required to decode the data information in the transmission.

The parameters of an SDU/PDU (e.g., segment) may include one or more of the following: the SDU/PDU Importance, which may be used to indicate the importance of the PDU set associated with the PDU, the relative Importance of the PDU in the PDU set, the relative Importance of the PDU in a Data Burst, and/or the relative Importance of the PDU in the QoS flow; the priority associated with the SDU/PDU; the latency requirement of the SDU/PDU (segment); the synchronization window, which may be used to describe the synchronization requirement between two or more interdependent SDU/PDUs; the remaining synchronization window and/or the remaining time to serve (e.g., to transmit/receive) the SDU/PDU, e.g., which may be used to describe the remaining time to serve the second SDU/PDU upon transmission/reception of the first interdependent SDU/PDU (e.g., due to synchronization requirement between the SDU/PDU and another interdependent SDU/PDU); the reliability requirement of the SDU/PDU (e.g., Packet Error Rate (PER)); the residual error requirement of an information unit (e.g., Bit Error Rate, Block Error Rate, and/or the like); the maximum Data Burst Volume (MDBV); the traffic type of the SDU/PDU (e.g., segment) (e.g., periodic vs. aperiodic); the periodicity of the PDU/PDU-segment; and/or the size of the PDU/PDU-segment.

The latency requirement of the SDU/PDU (e.g., segment) may include one or more of the following: Packet Delay Budget (PDB); remaining PDB; time to transfer, e.g., a radio-level latency bound for initiating and/or completing transmission of data; transmission time period, e.g., a radio-level transmission interval during which the transmission of the data is initiated and/or completed.

For example, to satisfy the QoS requirement of an XR service, the WTRU may deliver (e.g., may need to deliver) two interdependent SDU/PDUs within the synchronization window. Upon transmission/reception of the first SDU/PDU, the WTRU may transmit/receive (e.g., may need to transmit/receive) the second interdependent SDU/PDU within the synchronization window.

The parameters of the PDU set may include one or more of the following: PDU Set Importance (e.g., PSI), which may be used to indicate the relative importance of a PDU Set compared to other PDU Sets within a QoS Flow; the PDU set Priority; the synchronization window (e.g., remaining synchronization window), which may be used to describe the synchronization requirement between two or more interdependent PDU sets or the synchronization requirement between one PDU set and one or more other PDUs; a latency requirement associated with the PDU set (e.g., the PSDB (e.g., remaining PSDB), which may be used to indicate the maximum time between reception of the first PDU and the successful delivery of the last-arrived PDU of a PDU Set; the PDU Set Integrated Handling Indication (PSIHI) indicating whether one or more (e.g., all) PDUs of the PDU Set are needed for the usage of PDU Set by the application layer; the type of the PDU set; and/or the reliability requirement of a PDU Set, such as PDU Set Error Rate (PSER).

The synchronization window (e.g., remaining synchronization window), which may be used to describe the synchronization requirement between two or more interdependent PDU sets or the synchronization requirement between one PDU set and one or more other PDUs. For example, to satisfy the quality of experience (QoE) requirement of an XR service, the WTRU may need to deliver two interdependent PDU sets within the synchronization window. Upon transmission/reception of the first PDU set, the WTRU may need to transmit/receive the second interdependent PDU set within the synchronization window.

The type of the PDU set, which may include one or more of the following: the first type of PDU set, which may require reliable delivery of all PDUs in the set; the second type of PDU set, in which the transmission of a PDU set is unsuccessful when at least one (e.g., possibly specific) PDU fails transmission; and/or the third type of PDU set, in which the transmission of a PDU set is successful if (e.g., when) X PDUs of the PDU set of Y PDUs are received (e.g., if (e.g., when) Forward Error Correction (FEC) is used or if (e.g., when) additional layered encoding is used and assigned to the same PDU set).

The reliability requirement of a PDU Set, such as PSER, which may be used to indicate one or any combination of the following: the volume of the PDU set; the type of PDU set (e.g., periodic vs. aperiodic); and/or the periodicity of the PDU set.

The volume of the PDU set may include one or more of the following: the size of a (e.g., each) PDU and/or the number of PDUs in the PDU set.

One or more parameters of a data burst associated with the control/data unit, which may include the volume of the data burst. The volume of the data burst may include one or more of the following: the size of a (e.g., each) PDU in the data burst; the number of PDU sets in the data burst; and/or the volume of a (e.g., each) PDU set in the data burst.

One or more redundancy parameters (e.g., AL-FEC ratio associated with the control/data unit), which may be used to indicate the number of required PDUs to decode the PDU set and/or the maximum BER/BLER required to decode the data information in the transmission.

In some examples, a control/data unit may be a PDU set, in which the receiver may need to receive (e.g., successfully receive) at least K out of N PDUs in the PDU set to decode (e.g., successfully decode) the PDU set (e.g., successfully decode a video frame at the application layer). K or the ratio between K and N (e.g., K/N) may be used as one of the QoS parameters for the PDU set to represent the redundancy parameter for the PDU set.

In some examples, a control/data unit may be a PDU set, which may include multiple subsets of the PDU set. The WTRU may need (e.g., be required) to transmit (e.g., successfully transmit) a ratio or a certain number of PDUs of a (e.g., each) subset of the PDU set, e.g., to satisfy a certain QoS requirement. The ratio of a (e.g., each) PDU may be used as one or more QoS parameters for the PDU set, e.g., to represent the redundancy parameters for the PDU set.

QoS treatment profile may be associated with one control/data unit. An application may provide one or more IP flows for transmission over a medium. An (e.g., each) IP flow may go through a transport layer protocol (e.g., TCP/IP, Quick UDP Internet Connections (QUIC), real-time transport protocol (RTP), etc.). An (e.g., each) IP flow (e.g., a PDU session) may go through a RAN core network, which may map it to a RAN data flow or a RAN data set. For a (e.g., each) RAN data flow, the core network may attach some QoS requirements, a QoS metric, a range of QoE metrics, and/or the like.

A RAN data flow may represent a logical association between data units, e.g., originating from the same IP flow and/or subset of the related bitstream. Such association may be based on such data units being associated with the same IP flow, application flow, or having the same association packet marked either by the core network or the application.

Some RAN data flows may not originate from a user application. For example, some RAN data flows may originate from the control plane (e.g., control data and RAN signaling and configurations), an intelligence plane (e.g., data collected from AI/ML services), a computing plan (e.g., used for native computing for computing services), a system plane (e.g., data originating within the RAN, e.g., due to sensing or positioning services), and/or a security plane.

The WTRU may assign a QoS class to a (e.g., each) control/data unit within a RAN data flow for the purpose of characterization of how control/data should be transmitted. A protocol plane may include (e.g., contain) a control/data unit classification function for QoS class marking throughout the protocol chain. The QoS class may be determined in such a layer according to one or more configured or predefined rules. Such QoS class may be used in various layers within the data plan protocol chain for achieving a certain QoS requirement. A (e.g., each) QoS class may be associated with a QoS treatment profile in the RAN, which may be configured semi-statically or change dynamically. A (e.g., each) QoS treatment profile may include (e.g., contain) a number of parameters to control the RAN treatment of the data transmission/reception and a number of metrics to achieve the QoS/QoE level for a given layer in the protocol chain. A (e.g., each) QoS class or QoS treatment profile may be associated and/or configured with one or more QoS parameters (e.g., a priority, an importance level, a delay bound, a reliability level, a guaranteed bit rate, a maximum bit rate, and/or a maximum packet loss rate).

As described herein, QoS, QoS class, and/or QoS and QoS treatment profile associated with a control/data unit may be used interchangeably.

As described herein, delay-critical control/data may be used to indicate the control/data having the delay budget (e.g., remaining delay budget) being smaller than a configured threshold.

As described herein, high-importance control/data may be used to indicate the control/data associated with a QoS and/or QoS treatment profile, having the importance being greater than a configured threshold. A high-priority control/data may be used to indicate the control/data associated with a QoS and/or QoS treatment profile, having the priority being greater than a configured threshold.

Configuration and/or an indication of multi-part transmission may be described herein.

The WTRU may be configured with a multi-part resource.

In some examples, the WTRU may be configured to perform multiplexing and transmission using a multi-part resource. The multi-part resource may include (e.g., consist of) one, two, or more parts. A (e.g., each) part may be used to transmit a bit sequence (e.g., UCI for PHY uplink control information bits or TB for data from MAC). A (e.g., each) bit sequence for a (e.g., each) part may be encoded (e.g., encoded separately) using its individual coding schemes (e.g., a (e.g., each) bit sequence may use a configured coding scheme with its own associated cyclic redundancy check (CRC) and/or checksum for verifying and/or correcting the integrity of the bit sequence). The bit sequence for a (e.g., each) part of the resource may be mapped to the resources configured for its associated part.

The WTRU may determine the transmission resource for different parts of a multi-part resource.

In some examples, the WTRU may be configured to use different resources for a (e.g., each) part of the multi-part resource. The multi-part resource may be scheduled by the network as a configured grant or dynamic grant. The configured grant may be a type-1 or a type-2 configured grant. The type-1 configured grant may be indicated via RRC. The type 2 configured grant may be indicated by RRC and activated/deactivated by a DCI. The dynamic grant may be indicated via DCI. The different resources for the multi-part resources may be associated with one or more of the following: different time (e.g., time division multiplexing (TDM)), frequency (e.g., frequency division multiplexing (FDM)), code (e.g., code division multiplexing (CDM)), spatial (e.g., spatial division multiplexing (SDM)), layer, and/or antenna ports for a (e.g., each) part of the multi-part resource; and/or different channel format.

A (e.g., each) part of a resource may be contiguous or non-contiguous in time and/or frequency domain.

In an example, the WTRU may be configured with TDM, FDM, or TDM+FDM between two parts of a multi-part resource. For TDM between two parts of a multi-part resource, a (e.g., each) part of the resource may span over different sets of symbols, slots, and/or the like. For FDM between two parts of a multi-part resource, a (e.g., each) part of the resource may span over different frequency regions, resource pools, carriers, and/or bandwidth parts. For example, the WTRU may be scheduled with a two-part resource, in which the first part is in the first carrier and the second part is in another carrier. For TDM+FDM between two parts of a multi-part resource, a (e.g., each) part of the resource may be separated either in time and/or frequency domain. For SDM between two parts of a multi-part resource, the WTRU may be configured with two beams (e.g., SRS resource index (SRI)), in which the first part may be associated with the first beam (e.g., SRI) and the second part may be associated with the second beam (e.g., SRI).

In another example, the WTRU may be configured with a multi-part resource. The multi-part resource may have two parts separated in orthogonal codes (e.g., the two parts are separated in different OCCs or different cyclic shifts).

The different resources for multi-part resources may be associated with different channel formats. For example, the WTRU may be configured with one or more channel formats for a (e.g., each) part of a multi-part resource. For example, the WTRU may be configured to use PUSCH and/or PUCCH for a first part of a multi-part resource. The WTRU may be configured to use PUSCH for the second part of the multi-part resource.

The WTRU may be configured with transmission parameters for one and/or multiple parts of a multi-part resource.

In examples, the WTRU may be configured/indicated with one or any combination of the following parameters for transmission in one and/or multiple parts of a multi-part resource: the number of parts in the multi-part resource; the presence of one or more parts of the multi-part resource; the number of bits (e.g., UCI size, transport block size (TBS), MAC-CE format) in the bit sequence to transmit in a part of the multi-part resource; the CRC, polynomial and/or length thereof used for a (e.g., each) bit sequence; the format associated with the control/data unit (e.g., the UCI format, the MAC-CE format); the MCS; the set of resources used to transmit the bit sequence in a (e.g., each) part of the multi-part resource; the resource size (e.g., the number of resource elements (REs) for a part of the resource, the value of the beta offset to apply in a formula for determination of the amount of resource for a part of the grant, and/or the like; the channel format; the DMRS pattern; the transmission power (e.g., relative transmission power); an applicable transmission power offset; an applicable maximum power reduction (MPR); an applicable set of power control parameters, function, and/or power control loop; an applicable TCI state; and/or the beam (e.g., SRI) used for transmission in a (e.g., each) part of the resource.

The WTRU may be configured/indicated with the format associated with the control/data unit (e.g., the UCI format, the MAC-CE format). For example, the WTRU may be configured with a UCI format (e.g., a first UCI format) to transmit HARQ ACK/NACK, another UCI format (e.g., a second UCI format) to transmit CSI reporting, and another UCI format (e.g., a third UCI format) to transmit both HARQ ACK/NACK and CSI reporting.

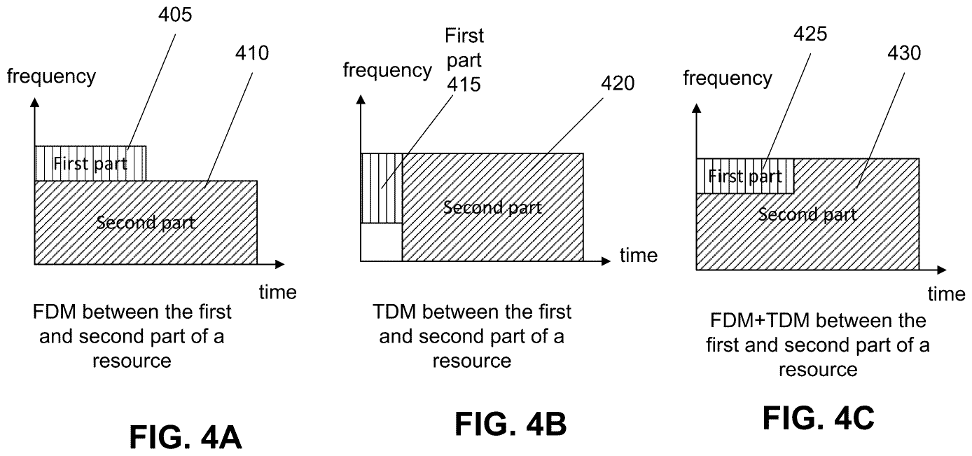

FIGS. 4A-C illustrate examples of the multiplexing between the first and the second part for a two-part resource. As illustrated in FIGS. 4A-C, the WTRU may be configured to perform multiplexing and transmission using a two-part resource. For example, FIG. 4A illustrates an example of the WTRU being configured to perform multiplexing and a transmission using a two-part resource, in which the first part (405) and the second part (410) may be multiplexed using FDM. FIG. 4B illustrates an example of the WTRU being configured to perform multiplexing and a transmission using a two-part resource, in which the first part (415) and the second part (420) may be multiplexed using TDM. FIG. 4C illustrates an example of the WTRU being configured to perform multiplexing and a transmission using a two-part resource, in which the first part (425) and the second part (430) may be multiplexed using FDM+TDM.

The WTRU may determine which control/data unit to multiplex in a part of resources.

The WTRU may be scheduled for a multi-part grant. The WTRU may use (e.g., then use) a (e.g., each) part to transmit one or any combination of the following: the transmission information of one or more other parts of the resources (e.g., the bit sequence of one part to indicate the information of one or more other parts that also may be considered as a new type of control/data unit); and/or a configured set of control/data, which may include RLC PDU (e.g., segment), MAC-CE, UCI.

In one example, the WTRU may be configured with a resource consisting of multiple (e.g., two) parts. A (e.g., each) part may be used to transmit a TB. The TB may be multiplexed from the data/control in the MAC buffer. The WTRU may be configured (e.g., be further configured) for which type of control/data unit to be multiplexed in a (e.g., each) part. For example, the WTRU may be configured to multiplex certain MAC-CEs (e.g., MAC-CE containing HARQ ACK/NACK feedback and/or CSI reporting) in one part.

In another example, the WTRU may be configured with a resource consisting of multiple (e.g., two) parts. One part (e.g., the first part) may be used to transmit UCI, which may include SR, HARQ ACK/NACK and/or CSI reporting. An (e.g., each) other part may be used to transmit TB, which may be multiplexed from the data/control in the MAC buffer.

In another example, the WTRU may be configured with a multi-part resource. One part may be used for UCI and a certain type of control/data unit from MAC (e.g., a certain MAC-CE, a certain type of data, and/or the like). Another part may be used to transmit a TB, which may include (e.g., consist of) a certain type of control/data unit at MAC.

In another example, the WTRU may be configured with a multi-part (e.g., two) resource. One part (e.g., the first part) may be used to indicate the information about another part (e.g., the second part). The information may include but not be limited to the TB size, the MCS, QoS/QoS treatment profile (e.g., delay budget, such as remaining delay budget, latency requirement, and/or the like), and/or the like. The second part may be used to transmit a TB, which is multiplexed from the data/control at MAC. Alternatively and/or additionally, the WTRU may be configured with a multi-part (e.g., two) resource, in which one part (e.g., the first part) may be used to transmit UCI and/or to implicitly/explicitly indicate the information about another part (e.g., the second part). The second part may be used to transmit a TB.

In another example, the WTRU may be configured with a multi-part (e.g., three) resource. The first part may be used to indicate the information about another part (e.g., the second part and/or the third part). The information may include, but not be limited to, the TB size, the MCS, the QoS/QoS treatment profile (e.g., priority, importance, delay budget, such as the remaining delay budget, and/or the like) associated with the control/data transmitted in the second and/or the third part. The second part may be used to transmit the first TB, which may be multiplexed from the control unit in the MAC/PHY layer (e.g., a MAC CE, a UCI). The third part may be used to transmit a second TB, which may be multiplexed from the data/control at MAC.

The WTRU may be configured to multiplex more than one control/data unit in a part (e.g., a single part).

The WTRU may multiplex more than one control/data unit within a part (e.g., a single part) of a multi-part resource. At least one of the more than one control/data unit may be encoded (e.g., separately encoded) from the remaining control/data units.

The WTRU may determine the number of resource elements, the number of modulation symbols, or the number of coded bits available for a (e.g., each) separately encoded set of control/data units, such that the sum of the number of resource elements, modulation symbols, or coded bits over one or more (e.g., all) separately encoded sets of control/data units is equal to or does not exceed the number of resource elements, and/or modulation symbols or coded bits for the single part.

Control/data may be multiplexed in a multi-part resource.

The WTRU may determine the priority for a (e.g., each) control/data unit for multiplexing in one part of a resource.

In one example, the WTRU may be configured with a multi-part resource. The WTRU may determine (e.g., then determine) the priority for a (e.g., each) control/data unit to multiplex in a (e.g., each) part of the grant. The priority for a (e.g., each) control/data unit to multiplex in a bit sequence for transmission in a part of the grant may be determined based on one or any combination of the following: the configured priority (e.g., the configured relative priority) associated with the control/data unit; the QoS/QoS treatment profile; and/or whether the control/data unit is subject to initial or retransmission.

As described herein, in examples, the priority for a (e.g., each) control/data unit to multiplex in a bit sequence for transmission in a part of the grant may be determined based on the configured priority (e.g., the configured relative priority) associated with the control/data unit. For example, the WTRU may be configured with a relative priority for a (e.g., each) type of control/data unit for transmission in a part of a grant (e.g., or in a part of resources indicated by the grant). The WTRU may determine (e.g., then determine) the priority for a (e.g., each) control/data unit based on the configured priority (e.g., the configured relative priority). For example, for transmission in a UCI part of a grant (e.g., the first part), the WTRU may be configured to prioritize HARQ ACK/NACK bits over CSI reporting.

As described herein, in examples, the priority for a (e.g., each) control/data unit to multiplex in a bit sequence for transmission in a part of the grant may be determined based on the QoS/QoS treatment profile. For example, the WTRU may determine the priority of a control/data unit based on the priority associated with the QoS treatment profile (e.g., RB/logical channel (LCH)) of the control/data unit. For example, the WTRU may determine the priority of a control/data unit based on the delay budget (e.g., the remaining delay budget) of the control/data unit.

As described herein, in examples, the priority for a (e.g., each) control/data unit to multiplex in a bit sequence for transmission in a part of the grant may be determined based on whether the control/data unit is subject to initial or retransmission. For example, the WTRU may be configured to prioritize a control/data unit subject to retransmission to multiplex in a bit sequence for transmission in a (e.g., one) part of a grant.

The WTRU may determine which control/data unit(s) and/or the number of bits to multiplex in a (e.g., each) part of a grant.

In one example, the WTRU may be configured with a multi-part resource. In examples, the WTRU may determine which control/data unit and/or the number of the control/data bits to multiplex in a (e.g., each) part of a grant. In examples, the WTRU may determine whether a (e.g., each) control/data unit may be multiplexed in a (e.g., one) part of the grant. Such decisions (e.g., which control/data unit and/or whether a control/data unit may be transmitted in a (e.g., each) part of the grant) may be determined based on one or any combination of the following: indication/configuration from the network; QoS/QoS treatment profile associated with the control/data unit; whether the control/data unit is subject to retransmission; whether the part of the grant has sufficient resources for the transmission of the control/data unit; and/or time-domain property of the grant.

In examples, the decisions (e.g., which control/data unit and/or whether a control/data unit may be transmitted in a (e.g., each) part of the grant) may be determined based on indication/configuration from the network.

In examples, for a (e.g., each) part of the multi-part resource, the WTRU may be configured (e.g., via RRC configuration) with a certain type of control/data units to multiplex in a bit sequence for transmission in the part of the resource. The WTRU may be configured with the maximum number of bits for a (e.g., each) type of control/data unit to multiplex in a (e.g., each) bit sequence for transmission in a (e.g., each) part of the multi-part resource. For example, for one part (e.g., the first part) of a multi-part grant, the WTRU may be configured to transmit UCI (e.g., SR, HARQ ACK/NACK, CSI report), e.g., to transmit UCI only. For example, for a (e.g., one) part of a multi-part resource, the WTRU may be configured to transmit a set of MAC-CEs (e.g., MAC-CE conveying HARQ ACK/NACK, CSI reporting). For example, for a (e.g., one) part of a multi-part resource, the WTRU may be configured to transmit a set of MAC-CEs and high-importance/priority and/or delay-critical data. For example, for a (e.g., one) part of a multi-part resource, the WTRU may be configured to transmit a TB. The TB may include (e.g., consist of) MAC-CE and data (e.g., RLC SDU or RLC SDU segment) from the upper layer.

In examples, the WTRU may be indicated from the network (e.g., via DCI) about which control/data units to transmit in a (e.g., each) part of a grant. For example, the WTRU may be configured (e.g., first configured) (e.g., via RRC configuration) with the possibility of multiple types of control/data and/or multiple formats of control/data (e.g., UCI for HARQ ACK/NACK, UCI for CSI reporting, short Buffer Status Report (BSR), long BSR, and/or the like) to multiplex in a part of a multi-part grant. The WTRU may receive (e.g., then receive) a DCI scheduling a multi-part uplink grant. The WTRU may be indicated (e.g., further indicated) (e.g., in the same scheduling DCI) about which control/data unit to multiplex in a (e.g., one) part of the grant. For example, the WTRU may be indicated (e.g., further indicated) whether to transmit UCI/MAC-CE for HARQ ACK/NACK and/or UCI/MAC-CE for CSI reporting in a (e.g., one) part of the resource.

In examples, the decisions (e.g., which control/data unit and/or whether a control/data unit may be transmitted in a (e.g., each) part of the grant) may be determined based on QoS/QoS treatment profile associated with the control/data unit.

In examples, the WTRU may determine whether to transmit a control/data unit in a (e.g., one) part of a resource based on the QoS associated with the control/data units. For example, the WTRU may transmit a control/data unit in a part of the resource (e.g., the first part to transmit important control/data) if the priority/importance associated with the control/data unit is greater than a configured threshold. For example, the WTRU may transmit the control/data unit in a part of the resource if the delay budget (e.g., remaining delay budget) of the control/data unit is smaller than a configured threshold.

In examples, the WTRU may determine which control/data unit to transmit in a part of a resource based on the priority associated with the control/data unit. For example, the WTRU may prioritize the high priority (e.g., the highest priority) control/data to multiplex in a part of the resource (e.g., the part with the most conservative MCS). This approach may be motivated to prioritize the treatment of the high priority (e.g., the highest priority) control/data.

In examples, the WTRU may determine which control/data unit to multiplex in a part of a multi-part resource based on the QoS treatment profile (e.g., the RB/LCH) associated with the resource. For example, the WTRU may be configured to multiplex control/data units from a set of QoS treatment profiles (e.g., a set of RBs/LCHs) for transmission in a part of the resource. For a (e.g., each) part of a resource, the WTRU may select (e.g., then select) the control/data units from the QoS treatment profiles (e.g., RBs/LCHs) configured for the part to multiplex in a bit sequence for transmission in the part of the resource. For example, the WTRU may be configured to transmit the control/data one in the high priority LCH (e.g., the highest priority LCH, such as LCH1) in a (e.g., one) part of the resource (e.g., in the first part). The WTRU may multiplex (e.g., then multiplex) the control/data of LCH1 to the first part of the resource upon being scheduled with a multi-part resource.

In examples, the decisions (e.g., which control/data unit and/or whether a control/data unit may be transmitted in a (e.g., each) part of the grant) may be determined based on whether the control/data unit is subject to retransmission.

For example, the WTRU may be configured to transmit control/data units subject to retransmission in a (e.g., one) part of a multi-part resource. The WTRU may multiplex (e.g., then multiplex) the control/data units subject to retransmission in the associated part of the resource.

In examples, the decisions (e.g., which control/data unit and/or whether a control/data unit may be transmitted in a (e.g., each) part of the grant) may be determined based on whether the part of the grant has sufficient resources for the transmission of the control/data unit.

For example, the WTRU may determine a coding rate (e.g., a maximum coding rate) and/or a spectrum efficiency (e.g., a maximum spectrum efficiency) for the transmission of the control/data unit. The coding rate (e.g., maximum coding rate) or the spectrum efficiency (e.g., maximum spectrum efficiency) may be based on (e.g., depend on) the QoS treatment profile associated with the control/data unit and/or on an indication from the network, such as a modulation and coding scheme. The WTRU may determine that the grant has sufficient resources if the available number of coded bits using an indicated modulation is higher than the number of information bits (e.g., including CRC, if any) of the control/data unit divided by the coding rate (e.g., the maximum coding rate). The WTRU may determine that the grant has sufficient resources if the available number of resource elements is higher than the number of information bits (e.g., including CRC, if any) of the control/data unit divided by the spectrum efficiency (e.g., the maximum spectrum efficiency).

For example, if the WTRU may multiplex more than one control/data unit in the part of the grant, the WTRU may make the determination for a control/data unit considering resources of the part of the grant that are not already allocated to other control/data units. The WTRU may allocate resources of a part of a grant to control/data units using a priority assigned to a (e.g., each) control/data unit. For example, the priority may be based on (e.g., depend on) the QoS treatment profile associated with the control/data unit.

In examples, the decisions (e.g., which control/data unit and/or whether a control/data unit may be transmitted in a (e.g., each) part of the grant) may be determined based on the time-domain property of the grant.

For example, the WTRU may prioritize usage of a part of the grant that is earlier in time (e.g., based on the last time symbol of the part) to a control/data unit based on QoS treatment profiles (e.g., such as latency requirements) associated with the control/data units. For example, the WTRU may multiplex the first and second control/data units in the first and second parts of a grant where the last symbol of the first part is earlier than the last symbol of the second part if the first control/data unit has a shorter latency budget than the second control/data unit.

The WTRU may determine to duplicate a control/data unit in multiple parts of a grant (e.g., PHY duplication).

In examples, the WTRU may be configured to perform PHY duplication by multiplexing a control/data unit in multiple parts of a grant. For example, the WTRU may be configured with a set of control/data units to multiplex in multiple bit sequences, in which a (e.g., each) bit sequence may be transmitted in a (e.g., one) part of the resource. The WTRU, upon the availability of the configured control/data unit and a multi-part grant, may perform (e.g., then perform) PHY duplication for the control/data unit. For example, the WTRU may multiplex (e.g., then multiplex) the control/data unit in multiple bit sequences, in which a (e.g., each) bit sequence may be transmitted in a (e.g., one part) of the resource.

For example, the WTRU may be configured with one or more MAC-CEs to convey HARQ ACK/NACK and/or CSI reporting. The WTRU may be configured to perform PHY duplication for these MAC-CEs. The WTRU may be scheduled with a two-part grant. The WTRU may perform (e.g., then perform) PHY duplication for one of the MAC-CEs, e.g., by multiplexing the MAC-CE in bit sequences (e.g., both bit sequences), in which a (e.g., each) bit sequence may be transmitted in a (e.g., one) part of the grant.

The WTRU may determine which control/data unit to multiplex in multiple parts of a grant (e.g., PHY duplication).

In examples, the WTRU may determine which control/data unit to multiplex in multiple parts of a grant (e.g., PHY duplication). In examples, the WTRU may determine whether a control/data unit is (e.g., can be) multiplexed in multiple parts of a grant. Such decision (e.g., which control/data unit and/or whether a control/data unit is subject to PHY duplication) may be determined based on one or any combination of the following: indication/configuration from the network; QoS/QoS treatment profile associated with the control/data unit; and/or whether the control/data unit is subject to retransmission.

The decision (e.g., which control/data unit and/or whether a control/data unit is subject to PHY duplication) may be determined based on an indication/configuration from the network. For example, the WTRU may be indicated/configured from the network of which control/data units to perform PHY duplication. For example, the WTRU may be configured/indicated to perform PHY duplication of UCI/MAC-CE for HARQ ACK/NACK and/or UCI/MAC-CE for CSI reporting.

The decision (e.g., which control/data unit and/or whether a control/data unit is subject to PHY duplication) may be determined based on QoS/QoS treatment profile associated with the control/data unit.

In examples, the WTRU may determine which control/data unit to perform PHY duplication based on the QoS/QoS treatment profile associated with the control/data unit. For example, the WTRU may select the control/data unit based on the priority (e.g., the one with the highest priority) to perform PHY duplication. For example, the WTRU may select the control/data unit based on the low delay budget (e.g., with the lowest remaining delay budget) to perform PHY duplication. For example, the WTRU may prioritize (e.g., first prioritize) performing PHY duplication for HARQ ACK/NACK and CSI reporting.

In examples, the WTRU may determine whether to perform PHY duplication for a control/data unit based on the QoS/QoS treatment profile associated with the control/data unit. For example, the WTRU may perform PHY duplication for a control/data unit if the priority/importance of the control/data unit is greater than a configured threshold. For example, the WTRU may perform PHY duplication for a control/data unit if the delay budget (e.g., remaining delay budget) of the control/data unit is smaller than a configured threshold.

In examples, the WTRU may determine which control/data unit to perform PHY duplication based on whether the control/data unit is subject to retransmission.

For example, the WTRU may determine to perform PHY duplication for a control/data unit subject to retransmission. The PHY duplication may help to increase the reliability of the retransmission.

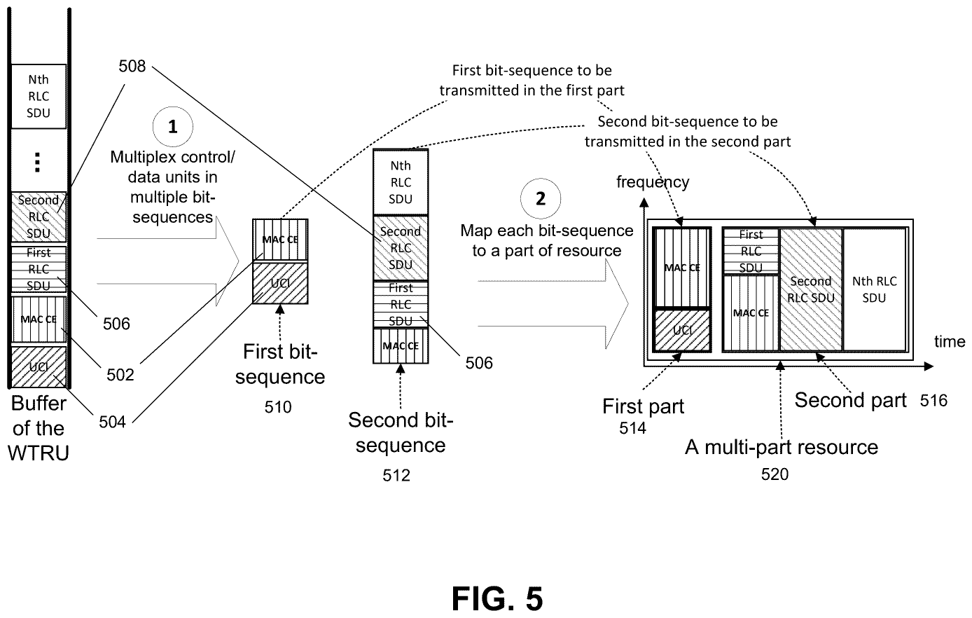

FIG. 5 illustrates an example of the WTRU performing PHY duplications for a MAC-CE in a multi-part resource. For example, FIG. 5 illustrates an example of PHY duplication. As illustrated in FIG. 5, the WTRU may perform PHY duplication for a MAC CE (502). For example, the WTRU (e.g., initially, the WTRU) may have UCI (504), MAC-CE (502), and multiple RLC SDUs (506, 508, etc.) to transmit in a two-part grant. As illustrated in FIG. 5 (e.g., as shown in the first step), the WTRU may multiplex (e.g., first multiplex) the control/data units into two bit sequences (e.g., first bit sequence (510) and second bit sequence (512)). A (e.g., each) bit sequence may be transmitted in one part of the resource. The first bit sequence (510) may include UCI (504) and MAC CE (502). The second bit sequence (512) may include the same MAC-CE (504) multiplexed in the first bit sequence (510) and multiple RLC SDUs (506, 508, etc.). As illustrated in FIG. 5 (e.g., as shown in the second step), the WTRU may transmit (e.g., then transmit) the first bit sequence (510) in the first part (514) and the second bit sequence (512) in the second part (516) of a multi-part resource (520).

The WTRU may perform multiplexing (e.g., sequential multiplexing) of control/data in multiple parts of a multi-part resource.

In examples, the WTRU may perform multiplexing (e.g., sequential multiplexing) of the control/data in multiple (e.g., two) parts of a resource. The WTRU may be configured with a set of control/data units to be able to be transmitted in parts (e.g., both parts) of a multi-part resource. The WTRU may perform (e.g., then perform) subsequent multiplexing of the control/data in the two parts of the resource. For example, the WTRU may multiplex (e.g., first multiplex) the control/data units in a bit sequence (e.g., the first bit sequence) for transmission in the first part. The WTRU may multiplex (e.g., then multiplex) the remaining control/data in another bit sequence (e.g., the second bit sequence) to transmit in the second part of the resource. The WTRU may determine the control/data units to be transmitted in the second part of the resource based on the remaining control/data units, e.g., after multiplexing the control/data units in the first bit sequence for transmission in the first part of the resource.

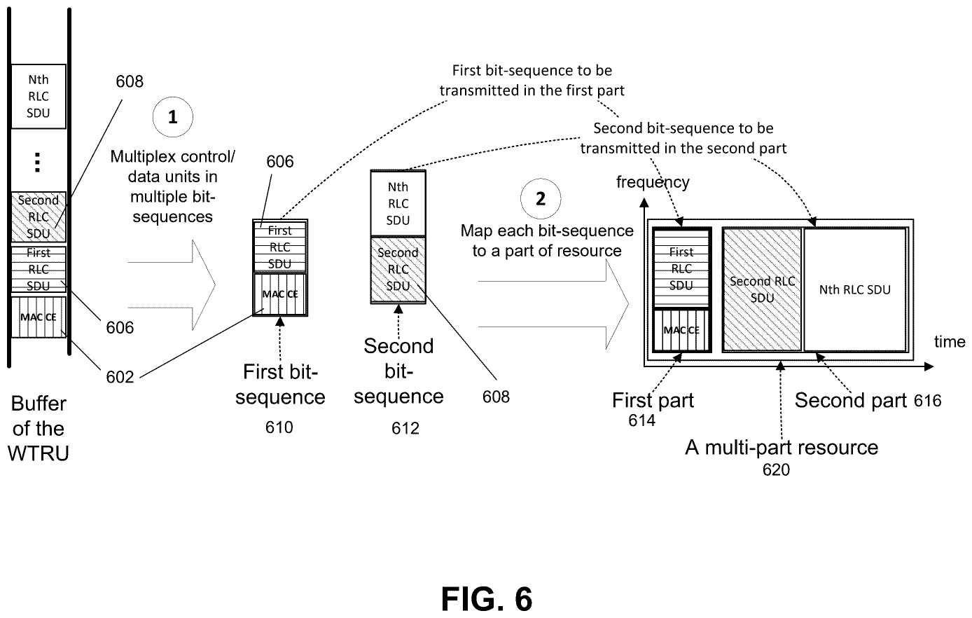

FIG. 6 illustrates the WTRU performing sequential multiplexing of control/data units in a multi-part resource.

In an example illustrated in FIG. 6, the WTRU may perform sequential multiplexing of control/data units to different bit sequence for transmission in different parts of a multi-part resource. The WTRU may be scheduled (e.g., first be scheduled) with a two-part resource (620). The WTRU may have a MAC CE (602) and multiple RLC SDUs (606, 608, etc.) in its buffer. The WTRU may multiplex (e.g., first multiplex) the control/data units in a first bit sequence (610) to transmit in the first part (614) of the resource. As illustrated in FIG. 6, the WTRU may multiplex MAC CE (602) and the first RLC SDU (606) in the first bit sequence (610). After multiplexing the control/data units in the first bit sequence (610), the WTRU may multiplex (e.g., then multiplex) the remaining control/data unit in the second bit sequence (612) to transmit in the second part (616) of the resource.

Determination and indication of one or more Tx parameters may be configured.

For example, the WTRU may determine the one or more transmission parameters for a (e.g., each) part and for multi-part resource.

The WTRU may determine one or any combination of the following transmission parameters for a (e.g., each) part of the grant and for the multi-part grant: the number of parts in the multi-part resource; the presence of one or more parts of the multi-part resource; the number of bits (e.g., UCI size, TBS, MAC-CE format, and/or the like) in the bit sequence to transmit in a part of the multi-part resource; the CRC used for each bit sequence; the format associated with the control/data unit (e.g., the UCI format, the MAC-CE format, and/or the like); the MCS; the set of resources used to transmit the bit sequence in each part of the multi-part resource; the resource size (e.g., the number of REs for a part of the resource, the value of the beta offset to apply in a formula for determination of the amount of resource for a part of the grant, and/or the like); the channel format; the DMRS pattern; the transmission power (e.g., relative transmission power); an applicable transmission power offset; an applicable maximum power reduction (MPR); an applicable set of power control parameters, function, and/or power control loop; an applicable TCI state; and/or the beam (e.g., SRI) used for transmission in a (e.g., each) part of the resource.

As described herein, the WTRU may determine the format associated with the control/data unit (e.g., the UCI format, the MAC-CE format, and/or the like) for a (e.g., each) part of the grant and for the multi-part grant. For example, the WTRU may be configured with one UCI format (e.g., a first UCI format) to transmit HARQ ACK/NACK, another UCI format (e.g., a second UCI format) to transmit CSI reporting, and another UCI format (e.g., a third UCI format) to transmit both HARQ ACK/NACK and CSI reporting.

As described herein, the WTRU may determine the channel format. For example, the WTRU may be configured to use one or more channel formats for a part of a multi-part resource. For example, the WTRU may be configured to use PUCCH or PUSCH for the first part of the resource.

Each transmission parameter may be determined/selected from a set of possible values and/or possible ranges, which may be configured by the network. One or more transmission parameters may be determined based on one or any combination of the following: the implicit/explicit indication from network; the QoS/QoS treatment profile associated with the transmitted control/data units in each part of the resource; the set of control/data bits multiplexed in a bit sequence to be transmitted in a (e.g., each) part (e.g., which may include the number of bits in the whole bit sequence, the number of bits for each type of control/data units (e.g., the number of bits for HARQ ACK/NACK, CSI report, and/or data), and/or the availability of a certain type of control/data (e.g., the availability of UCI, MAC-CE, and/or the availability of the data having priority being greater than a configured threshold); the resource size for a part of the multi-part resource; the resource size used for one or more other parts of the resource; the availability of an associated control/data associated with each part of the resource; and/or the transmission parameters associated with an associated part of the multi-part resource.

One or more transmission parameters may be determined based on the implicit/explicit indication from the network. In examples, the WTRU may determine the number of parts in a scheduled resource based on the indication from the network. In examples, the WTRU may determine the number of bits (e.g., UCI size, TBS, and/or the like) for a (e.g., each) bit sequence to transmit in a (e.g., each) part of the multi-part resource based on the implicit/explicit indication from the network. In examples, the WTRU may determine a format associated with the control/data unit (e.g., the UCI format, the MAC-CE format, and/or the like) based on the indication from the network. In examples, the WTRU may determine the resource size for each part of a multi-part resource based on the indication from the network.

In examples, the WTRU may determine the number of parts in a scheduled resource based on the indication from the network.

In some examples, the WTRU may receive the indication of the number of parts for a (e.g., each) multi-part resource for a configured grant. For example, the WTRU may be scheduled a configured grant (e.g., type 1 or type 2 configured grant). The WTRU may be indicated the number of parts and the time-frequency resource for a (e.g., each) part of the multi-part resource. Such indication may be indicated in the RRC for type 1 configured grant, and it may be indicated in RRC and/or DCI for type 2 configured grant.

In some examples, the WTRU may be indicated by the network, e.g., the number of parts in a scheduled resource in the DCI. For example, the WTRU may be configured with a DCI format for multi-part resource scheduling. The WTRU may be configured with a (e.g., one) bitfield, which may indicate the number of parts for the multi-part resource.

In examples, the WTRU may determine the number of bits (e.g., UCI size, TBS, and/or the like) for a (e.g., each) bit sequence to transmit in a (e.g., each) part of the multi-part resource based on the implicit/explicit indication from the network.

In some examples, the WTRU may be configured with a multi-part grant, in which the first part may be used for transmission of UCI conveying HARQ ACK/NACK and/or CSI reporting. The WTRU may be configured with a DCI format to receive a multi-part resource scheduling, in which the WTRU may be configured with a bitfield to indicate the size of the bit sequence to transmit in the first part. The WTRU may receive (e.g., then receive) a DCI scheduling a multi-part grant. The WTRU may determine (e.g., then determine) the size of the bit sequence to be transmitted in the first part of the grant based on the indicated codepoint in the associated bitfield of the received DCI.

In some examples, the WTRU may be configured (e.g., via RRC configuration) with a mapping between the size of the bit sequence for transmission in a part of a grant and the scheduled resource size for the part. The WTRU may determine (e.g., then determine) the size of the bit sequence to be transmitted in the part based on the scheduled resource size associated with the part, which may be indicated in a scheduling DCI.

In examples, the WTRU may determine a format associated with the control/data unit (e.g., the UCI format, the MAC-CE format, and/or the like) based on the indication from the network.

For example, the WTRU may be indicated (e.g., in DCI) to transmit a UCI format including (e.g., consisting of) HARQ ACK/NACK bits in a (e.g., one) part (e.g., the first part) of a multi-part resource. The WTRU may transmit (e.g., then transmit) the indicated UCI format in the indicated part of the resource. In another example, the WTRU may be indicated to transmit a UCI format including (e.g., consisting of) CSI report bits in the first part of the resource. The WTRU may transmit (e.g., then transmit) the indicated UCI format in the indicated part of the resource. In another example, the WTRU may be indicated to transmit a UCI format including (e.g., consisting of) both HARQ ACK/NACK bits and CSI report bits in one part (e.g., second part) of the resource.

In examples, the WTRU may determine the resource size for a (e.g., each) part of a multi-part resource based on the indication from the network.

For example, the WTRU may be scheduled/indicated (e.g., via DCI) the resource for a two-part resource. The WTRU may be indicated (e.g., further be indicated) (e.g., via the same DCI) one or more parameters (e.g., beta-offset) to determine the size of the first part. The WTRU may determine (e.g., then determine) the set of REs used for the first part. The WTRU may use the remaining resource for the second part.

One or more transmission parameters may be determined based on the QoS/QoS treatment profile associated with the transmitted control/data units in a (e.g., each) part of the resource.

In one example, the WTRU may be scheduled with a multi-part grant, in which the second part may be used to transmit the specific type of control/data (e.g., the control/data having the priority being greater than a configured threshold). The transmission in the second part may use a transmission parameter (e.g., a conservative transmission parameter), such as extremely low MCS (e.g., small modulation such as Quadrature Phase Shift Keying (QPSK), binary Phase Shift Keying (BPSK) and small coding rate). The WTRU may determine (e.g., then determine) whether to transmit the second part of the resource based on the availability of the special type of the control/data. For example, the WTRU may transmit the second part of the grant if the special type of control/data is available. Otherwise, the WTRU may not transmit (e.g., skip transmitting) the second part of the resource. The WTRU may indicate the availability of the second part of the second part of the resource in the first part of the resource.

In another example, the WTRU may determine the number of bits in a bit sequence to transmit in a part of a multi-part resource based on the QoS of the data/control multiplexed in the bit sequence. For example, the WTRU may be configured with a range of the size of a bit sequence per priority of the bit sequence. The WTRU may determine (e.g., then determine) which size of a bit sequence to transmit based on the priority of the bit sequence.

In another example, the WTRU may determine the number of bits for CRC check for a bit sequence to be transmitted in a part of a multi-part resource based on the priority associated with the bit sequence. For example, the WTRU may be configured with a size of CRC bits as a function of the priority of a bit sequence. The WTRU may determine (e.g., then determine) the size of CRC bits based on the priority of the bit sequence. For example, the WTRU may use 24 CRC bits for the high priority bit sequence (e.g., the highest priority bit sequence). The WTRU may use 8 CRC bits for the low bit sequence (e.g., the lowest priority bit sequence) for transmission in a part of a multi-part resource.

In another example, the WTRU may determine the MCS for the bit sequence in a part of a resource (e.g., the second part) based on the priority associated with the bit sequence. The priority of the bit sequence may be determined based on the priority associated with the control/data unit multiplexed in the bit sequence. For example, the WTRU may be configured with a range of MCS for a (e.g., each) priority of the bit sequence. The WTRU may determine (e.g., then determine) which MCS to use based on the priority of the bit sequence. The WTRU may indicate (e.g., then implicitly/explicitly indicate) the MCS used for transmission of the bit sequence in the associated part of the multi-part resource.

In another example, the WTRU may determine the resource size for a part of a resource based on the priority associated with the bit sequence. For example, the WTRU may be configured to transmit a fixed size of bit sequence in a part of a multi-part resource. The WTRU may be configured (e.g., further configured) with one or more sizes of resources based on the priority of the bit sequence. The WTRU may determine (e.g., then determine) the size of the resource (e.g., number of REs, beta offset, and/or the like) to transmit the bit sequence in a (e.g., one) part of the resource based on the priority of the bit sequence.

In another example, the WTRU may use a dense DMRS pattern for a high priority bit sequence for transmission in a part of a multi-part resource. For example, the WTRU may use a front-loaded DMRS pattern if the latency requirement of the TB is smaller than a configured threshold.

In another example, the WTRU may be configured to perform power boosting for a part of a resource (e.g., the second part of the resource) based on the priority associated with the control/data unit transmitted in the part of the resource. For example, if the priority associated with the control/data unit in the resource is larger than a configured threshold, the WTRU may not perform power boosting (e.g., 3 dB increases compared to the default power). Otherwise, the WTRU may allocate the same power compared to other parts of the resource.

One or more transmission parameters may be determined based on the set of control/data bits multiplexed in a bit sequence to be transmitted in a (e.g., each) part, which may include the number of bits in the whole bit sequence, the number of bits for a (e.g., each) type of control/data units (e.g., the number of bits for HARQ ACK/NACK, CSI report, and/or data), and/or the availability of a certain type of control/data (e.g., the availability of UCI, MAC-CE, and/or the availability of the data having priority being greater than a configured threshold).

In one example, the WTRU may be configured with a fixed MCS for transmission in a (e.g., one) part of a multi-part resource. The WTRU may have the flexibility to select the resource size of one part of the resource. The WTRU may determine (e.g., then determine) the resource size (e.g., number of REs) for transmission of a bit sequence in the part of the resource based on the size of the bit sequence to be transmitted in the part.

In another example, the WTRU may determine the size of CRC bits based on the size of the bit sequence to be transmitted in a part of a multi-part resource. For example, the WTRU may be configured to use a (e.g., one) size of CRC bit for a range of sizes of a bit sequence. The WTRU may determine (e.g., then determine) which CRC size to use based on the size of its bit sequence.

In another example, the WTRU may be configured to transmit UCI (e.g., HARQ ACK/NACK, and/or CSI report) and data in a part of the resource. The WTRU may determine the MCS for a bit sequence for transmission in a part based on the availability of UCI in the bit sequence. For example, the WTRU may be configured to use one MCS if UCI is present and use another MCS if UCI is not present. The WTRU may determine (e.g., then determine) which MCS to use based on the presence of the UCI in the bit sequence.

One or more transmission parameters may be determined based on the resource size for a part of the multi-part resource.

In one example, the WTRU may determine the size of a bit sequence to be transmitted in a (e.g., one) part of a multi-part resource based on the resource size of the part. For example, the WTRU may multiplex the control/data units in a bit sequence until it reaches the allowed bits (e.g., the maximum allowed bits) for a resource size.

In another example, the WTRU may determine the MCS used for transmission of a bit sequence in a part (e.g., the second part) of a multi-part (e.g., three part) grant based on the resource size scheduled for the part. For example, the WTRU may be configured to transmit a specific size bit sequence in a (e.g., one) part (e.g., the second part) of a grant. The WTRU may determine (e.g., then determine) which MCS from the set of configured MCS index to use for transmission in the part based on the scheduled resource size for the part (e.g., the second part). The WTRU may indicate (e.g., then indicate) the determined MCS for the second part in the first part of the grant.

In another example, the WTRU may be configured with multiple MAC CE formats (e.g., normal BSR, truncated BSR, padding BSR, short-BSR, and/or the like) to be transmitted in a (e.g., one) part of a multi-part resource. The WTRU may determine (e.g., then determine) which MAC CE format to use based on the resource size scheduled for the part of the resource. For example, the WTRU may transmit short-BSR if the scheduled resource size of the part is smaller than a threshold, which may be used to determine whether the WTRU can transmit long-BSR. If the WTRU is scheduled with a large resource size for the part of the resource (e.g., the resource size is larger than the threshold), the WTRU may transmit a long-BSR.

In another example, the WTRU may be configured to transmit multiple MAC CE formats for conveying HARQ ACK/NACK, and/or CSI report. The WTRU may determine (e.g., then determine) which MAC CE format to transmit based on the size of the resource. For example, the WTRU may transmit MAC CE conveying HARQ ACK/NACK if (e.g., only if) it is scheduled with a small resource size (e.g., the resource size is smaller than a threshold) for transmission in a (e.g., one) part of a multi-part resource. Alternatively and/or additionally, the WTRU may transmit MAC CE conveying HARQ ACK/NACK and/or CSI (e.g., both HARQ ACK/NACK and CSI) if it is scheduled with a large resource size (e.g., the resource size is larger than a threshold) for transmission in a (e.g., one) part of a multi-part resource.

In another example, the WTRU may be configured to transmit a (e.g., one) UCI format out of multiple possible UCI formats to be transmitted in a (e.g., one) part (e.g., the first part). The possible UCI format may include the UCI format to transmit HARQ ACK/NACK bits (e.g., bits only), the UCI format to transmit CSI reporting (e.g., reporting only), and/or the UCI format to transmit both HARQ ACK/NACK and CSI reporting bits. The WTRU may determine (e.g., then determine) which UCI format to transmit in the second part of the resource based on the scheduled resource size of the second part. For example, if the resource size of the second part is smaller than the first threshold, the WTRU may transmit the UCI format, including (e.g., consisting of) HARQ ACK/NACK bits only. If the resource size is larger than the first threshold but smaller than the second threshold, the WTRU may transmit the UCI format including (e.g., consisting of) CSI reporting (e.g., CSI reporting only). If the scheduled resource for the second part is larger than the second threshold, the WTRU may transmit the UCI format, including (e.g., consisting of) both HARQ ACK/NACK bits and CSI reporting.

One or more transmission parameters may be determined based on the resource size used for one or more other parts of the resource.

In one example, the WTRU may be configured with a fixed size resource for multi-part transmission. The WTRU may determine (e.g., then determine) the resource size associated with the last part of the resource based on the total size used for the other parts of the resource. For example, the WTRU may be configured with a two-part resource. The WTRU may determine (e.g., first determine) the resource size for the first part of the resource. For example, the resource size for the first part of the resource may be selected from the set of configured possible sizes for the first part of the resource. Based on the determined size of the first part of the resource, the WTRU may use (e.g., then use) the remaining resource as the second part.

One or more transmission parameters may be determined based on the availability of an associated control/data associated with a (e.g., each) part of the resource.

For example, the WTRU may determine the number of parts for a multi-part transmission based on the availability of control/data associated with a (e.g., each) part of the resource. For example, the WTRU may be configured to transmit one or more MAC-CEs in a (e.g., one) part (e.g., the second part) of a three-part resource. The first part of the resource may be used to indicate the information associated with the second part of the resource. The WTRU may perform (e.g., then perform) a two-part resource if (e.g., only if) there is no available MAC CE to be transmitted in the second part of the resource. The WTRU may use (e.g., then use) the first part to indicate to the network that there is no second part of the resource.

One or more transmission parameters may be determined based on the transmission parameters associated with an associated part of the multi-part resource.

For example, the WTRU may be configured to use the same modulation between the second and the third part of a three-part resource. The WTRU may determine (e.g., then determine) the modulation associated with the second part based on the modulation used in the third part of the resource.

The WTRU may select one of a set of multi-part resources.

In some examples, the WTRU may receive configuration and/or indication for a set of more than one multi-part grant and select one multi-part grant from the set. The WTRU may determine that it needs to select if, for example, the grants are overlapping in time-domain and/or frequency-domain, if the grants share the same identifier, and/or if the grants are indicated from the same downlink control indication or PDCCH. The WTRU may select the grant based on at least one of the following criteria: a grant that maximizes the amount of data transmitted of control/data units, possibly following a priority order; a grant for which the resulting power headroom is below a configured or pre-defined threshold, such as 0 dB; a grant that satisfies latency requirements and/or QoS requirements of all control/data units, when applicable; and/or a priority order associated with or configured for a (e.g., each) grant.

The WTRU may select the grant of high priority (e.g., the highest priority) that satisfies a set of applicable condition(s) such as described herein.

The WTRU may indicate the selected multi-part resource by encoding its identity in a transmission separate from the multi-part resource (e.g., an earlier transmission) or within a part of the selected multi-part resource.

The WTRU may use a (e.g., one) part to indicate the transmission of one or more other parts of a resource.

The WTRU may be scheduled/configured with a multi-part resource. The WTRU may use (e.g., then use) a (e.g., one) part of the resource to indicate the transmission parameters associated with one or more other parts of the resources. If the WTRU selects one from a set of multi-part resources, the WTRU may indicate the selected multi-part resource in one part of the selected resource. For example, the WTRU may use a (e.g., one) part of the resource to implicitly/explicitly indicate one or any combination of the following information about the other parts of the multi-part resource: the availability/presence of another part of the resource; one or more transmission parameters associated with one or more other parts of the resource; and/or the property of the control/data unit multiplexed in one or more of other parts.

For example, the WTRU may be configured with a three-part resource. The WTRU may use the first part of the resource to indicate the availability/presence of the second part of the resource.

One or more transmission parameters may be associated with one or more other parts of the resource. For example, the WTRU may use a (e.g., one) part of the resource to indicate one or more of the following parameters associated with another part of the resource: the number of bits (e.g., UCI size, TBS, MAC-CE format, and/or the like) in the bit sequence to transmit in the other part of the resource; the CRC used for the bit sequence transmitted in the other part of the resource; the format associated with the control/data unit (e.g., the UCI format, the MAC-CE format, and/or the like) transmitted in the other part of the resource; the MCS; the set of resources used to transmit the bit sequence in the other part of the resource; the resource size (e.g., the number of REs for a part of the resource, the value of the beta offset); the channel format; the DMRS pattern; the transmission power (e.g., relative transmission power); and/or the beam (e.g., SRI) used for transmission in the other part of the resource.

In examples, the WTRU may use one part of the resource to indicate the format associated with the control/data unit (e.g., the UCI format, the MAC-CE format, and/or the like) transmitted in the other part of the resource associated with another part of the resource. For example, for transmission in another part of the resource, the WTRU may be configured with one UCI format (e.g., a first UCI format) to transmit HARQ ACK/NACK, another UCI format (e.g., a second UCI format) to transmit CSI reporting, and another UCI format (e.g., a third UCI format) to transmit both HARQ ACK/NACK and CSI reporting. The WTRU may indicate which format associated with the control/data unit is transmitted in the indicated part.

In examples, the WTRU may use one part of the resource to indicate the set of resources used to transmit the bit sequence in the other part of the resource. For example, the WTRU may indicate the time/frequency information to help the network in determining the set of REs used by the WTRU to transmit the bit sequence in the other part of the resource.

The property of the control/data unit multiplexed in one or more of other parts. For example, the WTRU may use a (e.g., one) part of the resource to indicate one or more of the following properties of the control/data unit multiplexed in the other part of the resource: the QoS associated with the control/data unit transmitted in the second part of the resource; and/or the availability of a certain control/data unit.

In examples, the WTRU may use a (e.g., one) part of the resource to indicate the QoS associated with the control/data unit transmitted in the second part of the resource in the other part of the resource. For example, the WTRU may use one part of the resource to indicate the priority, delay budget (e.g., remaining delay budget), and/or the importance of the other part of the resource.

In examples, the WTRU may use a (e.g., one) part of the resource to indicate the availability of a certain control/data unit in the other part of the resource. For example, the WTRU may use a (e.g., one) part of the resource to indicate the availability of a certain UCI in the other part of the resource. For example, the WTRU may use one part of the resource to indicate the availability of a UCI for HARQ ACK/NACK and/or CSI reporting. For example, the WTRU may use a (e.g., one) part of the resource to indicate the availability of a certain configured MAC-CE. For example, the WTRU may use a (e.g., one) part of the resource to indicate the availability of a BSR, data status report (DSR), and/or power headroom report (PHR). For example, the WTRU may use a (e.g., one) part of the resource to indicate the availability of a MAC-CE, including (e.g., consisting of) HARQ ACK/NACK and/or CSI reporting.

In one example, the WTRU may be configured with a two-part resource. The WTRU may be configured to transmit one or more UCI format (e.g., in the first part of the resource) transmission parameters associated with the second part of the resource. The WTRU may be configured with multiple bitfields, in which a (e.g., each) bitfield may be used to indicate on transmission parameters associated with the second part of the resource. For example, the WTRU may use a (e.g., one) bitfield to indicate the MCS/TBS associated with the second part of the resource. The WTRU may use another bitfield to indicate the set of resources used for transmission in the second part of the resource.

In another example, the WTRU may be configured with a two-part resource. The WTRU may be configured to transmit a (e.g., one) UCI format (e.g., in the first part of the resource) to indicate the property of the control/data unit multiplexed in the second part of the resource. The WTRU may use a (e.g., one) bitfield in the UCI format to indicate the latency associated with the bit sequence transmitted in the second part of the resource. The WTRU may use another bitfield to indicate the availability of a MAC-CE from a set of configured MAC-CEs. The set of configured MAC-CE may include BSR, DSR, PHR, MAC-CE, and/or the like to convey HARQ ACK/NACK, and/or CSI report. The WTRU may use another field to indicate the priority/importance associated with the bit sequence transmitted in the second part of the grant.

FIG. 6 illustrates an example of the WTRU being configured with a multi-part resource. For example, as illustrated in FIG. 6, the WTRU may use the first part to indicate the transmission information about the second part. As further illustrated in FIG. 6, the WTRU may be configured with a three-part resource. The three-part resource may include the first part, the second part, and the third part. The WTRU may use the first part to transmit a UCI format to indicate the transmission information of the second part and/or the third part. The WTRU may use the second part to transmit a MAC-CE including (e.g., containing) HARQ ACK/NACK and/or CSI reporting. The WTRU may use the third part to transmit a TB. For the UCI format to be transmitted in the first part, the WTRU may be configured with a bitfield to indicate the set of resources used for the second part, which may indicate (e.g., implicitly indicate) the resources used for the third part. The WTRU may be configured with a (e.g., one) codepoint to indicate the absence of the second part of the resource (e.g., one codepoint to indicate zero resource is used for the second part of the resource). The WTRU may be configured to use a (e.g., one) bitfield to indicate the TBS to be transmitted in the third part. The WTRU may be configured to use a (e.g., one) bitfield to indicate the priority/importance of the TB transmitted in the third part.

The WTRU may determine the priority for a multi-part resource transmission. Such determined priority may be used for the WTRU to perform prioritization among multiple transmissions/receptions. For example, the WTRU may prioritize the first transmission/reception over the second transmission/reception if the priority associated with the first transmission/reception is higher than the second transmission/reception. The priority associated with multi-part resource transmission may be determined based on one or any combination of the following: an indication from the network; the high priority (e.g., the highest priority) of one or more (e.g., all) the control/data units to be transmitted in the resource; and/or the high priority (e.g., the highest priority) of the control/data unit to be transmitted in a (e.g., one) specific part of the resource.

The priority associated with multi-part resource transmission may be determined based on an indication from the network. For example, the WTRU may be indicated (e.g., via DCI or RRC) the priority associated with the transmission of a scheduled multi-part resource.

The priority associated with multi-part resource transmission may be determined based on the high priority (e.g., the highest priority) of the control/data unit to be transmitted to a (e.g., one) specific part of the resource. For example, the WTRU may be configured with a two-part resource. The first part (e.g., of the two-part resource) may be used to transmit UCI. Another part (e.g., the second part of the two-part resource) may be used to transmit TB. In one example, the priority associated with multi-part resource transmission may be determined based on the priority of the UCI. In another example, the priority associated with the resource may be determined based on the priority of the TB.

In examples, the priority associated with the muti-part resource transmission may be based on a property of the resource, such as a duration, a sub-carrier spacing, a number of resource blocks, a number of layers, a TCI state, an SRS resource or resource set indicator, a carrier, a waveform, and/or the like.

The WTRU may be configured to report control/data for multi-part transmission. For example, the WTRU may report the information about the control/data unit for multi-part transmission to the network.

In one example, the WTRU may trigger reporting the information about the control/data units in its buffer to the network, which may be used by the network to schedule a multi-part resource. For example, the WTRU may use UCI (e.g., SR) to indicate the availability of the control/data units for potential multi-part transmission. The WTRU may use (e.g., then use) MAC CE (e.g., multi-part transmission status reporting) to indicate the detailed information of the control/data units for multi-part transmission upon reception of an uplink grant. The WTRU may report one or any combination of the following information about the data/control units in a multi-part transmission status reporting (MPTSR) for potential multi-part uplink transmission: the availability/amount of control/data and potentially its associated QoS parameters (e.g., priority) associated with one or more parts of multi-part resources; the amount/availability of control/data unit satisfying the configured condition; and/or the preferred transmission parameters (e.g., the preferred number of parts in a multi-part resource, the preferred parts of the multi-part resource, the preferred number of bits (e.g., UCI size, TBS, MAC-CE format, and/or the like) in the bit sequence to transmit in a (e.g., each) part of the multi-part resource, the preferred CRC used for a (e.g., each) bit sequence, the preferred format associated with the control/data unit (e.g., the UCI format, the MAC-CE format), the preferred MCS, the preferred resource size for a (e.g., each) part and one or more (e.g., all) parts (e.g., the number of REs for a part of the resource, the value of the beta offset to apply in a formular for determination of the amount of resource for a part of the grant, and/or the like), the preferred channel format, the preferred DMRS pattern, the preferred transmission power (e.g., relative transmission power) for one or multiple parts of one or more multi-part resource).

In examples, the WTRU may report the availability/amount of control/data and potentially its associated QoS parameters (e.g., priority) associated with one or more parts of multi-part resources.

In one example, the WTRU may be configured with a set of control/data associated with a set of QoS/QoS-treatment profiles to be transmitted in a (e.g., each) part of a multi-part resource. The WTRU may report (e.g., then report) the availability/amount of control/data to be transmitted in a (e.g., each) part of the resource and potentially its associated QoS parameters (e.g., priority, RB/LCH/logical channel group (LCG) associated with the control/data units, and/or the like).

In another example, the WTRU may be configured to transmit one or more MAC-CEs and/or UCIs in a part (e.g., the first part) of a resource. The WTRU may report (e.g., then report) the availability/amount of the control/data (e.g., the availability of MAC-CE, UCI, the size of MAC-CE, UCI, and/or the like) configured to transmit in the first part of a multi-part resource. The WTRU may report (e.g., also report) which MAC-CE format and/or UCI format is available in its buffer.

In another example, the WTRU may be configured with a set of control/data units associated with a set of QoS/QoS-treatment profiles for PHY duplication. The WTRU may report (e.g., then report) the availability/amount of control/data units subject to PHY duplication.

In examples, the WTRU may report the amount/availability of control/data unit satisfying the configured condition. For example, the WTRU may be configured with one or more properties of the control/data units to report to the network. The WTRU may report (e.g., then report) availability/amount of the control/data units satisfying the configured reporting condition.

For example, the WTRU may report the availability/amount of control/data having QoS/QoS treatment profile that satisfies a configured threshold/condition. For example, the WTRU may report the availability/amount of control/data associated with a configured set of QoS/QoS treatment profiles (e.g., a set of RBs/LCHs, a set of RBs/LCHs having priority being greater than a configured threshold, and/or the like). For example, the WTRU may be configured to report the availability/amount of control/data that belongs to a set of QoS/QoS treatment profile IDs. For example, the WTRU may be configured to report that the control/data belongs to a type of control/data such as system control/data.

In examples, the WTRU may report the preferred transmission parameters (e.g., the preferred number of parts in a multi-part resource, the preferred parts of the multi-part resource, the preferred number of bits (e.g., UCI size, TBS, MAC-CE format, and/or the like) in the bit sequence to transmit in a (e.g., each) part of the multi-part resource, the preferred CRC used for a (e.g., each) bit sequence, the preferred format associated with the control/data unit (e.g., the UCI format, the MAC-CE format), the preferred MCS, the preferred resource size for a (e.g., each) part and one or more (e.g., all) parts (e.g., the number of REs for a part of the resource, the value of the beta offset to apply in a formular for determination of the amount of resource for a part of the grant, and/or the like), the preferred channel format, the preferred DMRS pattern, the preferred transmission power (e.g., relative transmission power) for one or multiple parts of one or more multi-part resource). The values of the preferred one or more transmission parameters may be determined based on the buffer status of the WTRU. The preferred transmission parameters may be (e.g., also be) indicated to the WTRU via another message, such as RRC (e.g., UEAssistantInformation or WTRUAssistantInformation).

For example, the WTRU may be configured to transmit high-importance data in the first part of a multi-part resource. The WTRU may report (e.g., then report) the preferred size of bit sequence to be transmitted in the first part. The WTRU may report the preferred size of the resource for the first part. For example, the WTRU may report the preferred format (e.g., UCI format, MAC-CE format, and/or the like) for transmission to transmit in the first part of the resource.

The WTRU may trigger SR/MPTSR reporting based on a configured trigger condition.

The WTRU may be configured with one or more triggering conditions for the transmission of UCI/MAC-CE (e.g., SR/MPTSR) to report the information about the control/data units for multi-part transmission. Upon the triggering condition being satisfied, the WTRU may trigger transmission of UCI/MAC-CE (e.g., SR/MPTSR). The triggering condition may include one or any combination of the following events: the availability/amount of control/data units for a (e.g., each) part and/or multiple parts transmission; the QoS (e.g., the delay budget, such as the remaining delay budget) associated with the control/data satisfied a configured threshold; a periodic reporting event; and/or the availability of a transmission resource.

The triggering condition may include the availability/amount of control/data units for a (e.g., each) part and/or multiple parts transmission. For example, the WTRU may be configured with a set of control/data units to transmit in a (e.g., each) part of a multi-part resource. The WTRU may trigger (e.g., then trigger) transmission of SR/MPTSR if it has control/data available for transmission in one or multiple parts of a multi-part resource. For example, the WTRU may be configured to transmit delay-critical control/data, which has the delay budget (e.g., the remaining delay budget) being smaller than a configured threshold, in a (e.g., one) part of the resource. The WTRU may trigger (e.g., then trigger) reporting SR/MPTSR if it has a delay (e.g., delay critical) to be transmitted in the configured part. For example, the WTRU may be configured to transmit the control/data subject to retransmission. The WTRU may trigger (e.g., then trigger) transmission of SR/MPTSR if it has such control/data available in the buffer.

For example, the WTRU may trigger transmission of SR/MPTSR if the amount of data/control to be transmitted in a (e.g., one) part of a multi-part resource is greater than a configured threshold.

The triggering condition may include the QoS (e.g., the delay budget, such as the remaining delay budget) associated with the control/data that satisfied a configured threshold. In examples, the WTRU may trigger transmission of MPTSR if it has delay-critical and/or high priority/importance control/data units subject to initial transmission and/or retransmission. In examples, the WTRU may trigger transmission of MPTSR if it has a MAC-CE available from the set of configured MAC-CEs. For example, the WTRU may trigger transmission of MPTRS if it has available MAC-CE, including (e.g., containing) UCI (e.g., HARQ ACK/NACK information, CSI reporting, and/or the like) information.

The triggering condition may include a periodic reporting event. For example, the WTRU may be configured to report (e.g., periodically report) MPTSR. The WTRU may trigger (e.g., then trigger) MPTSR after a configured duration from the previous MPTSR reporting. For example, the WTRU may start a timer (e.g., periodic reporting timer) upon transmission of an MPTSR. The WTRU may trigger (e.g., then trigger) transmission of MPTSR upon expiry of the timer.

The triggering condition may include the availability of a transmission resource. For example, the WTRU may trigger transmission of MPTSR if it has resources for transmission. For example, if the WTRU still has resources for transmission after multiplexing control/data for a TB, the WTRU may opportunistically include MPTSR in the TB for transmission.

The WTRU may determine which MPTSR format to transmit.

In one example, the WTRU may be configured with multiple MPTSR formats. A (e.g., each) format may be associated with a (e.g., one) set of parameters and buffer status to convey to the network. A (e.g., each) format may be associated with a (e.g., one) format size. For example, the WTRU may be configured with a (e.g., one) MPTSR format in which a (e.g., each) report the availability/amount of control/data to be transmitted in a (e.g., each) part of a multi-part resource. The WTRU may be configured with an additional MPTSR format, in which the WTRU may report (e.g., may only report) the availability/amount of control/data to be transmitted in the first part of a multi-part resource. The first part of the resource may be used to transmit UCI, MAC CE, high priority/importance control/data (e.g., control/data having priority/importance being greater than a configured threshold), and/or delay-critical control/data (e.g., control/data having a delay budget (e.g., the remaining delay budget) being smaller than a configured threshold). The WTRU may determine (e.g., then determine) which format to use based on one or any combination of the following: the indication from the network; and/or the size of the resource to transmit MPTSR.

The WTRU may determine (e.g., then determine) which format to use based on the indication from the network. For example, the WTRU may be indicated by the network (e.g., via DCI) of which MPTSR to report. The WTRU may report (e.g., then report) the indicated format.

The WTRU may determine (e.g., then determine) which format to use based on the size of the resource to transmit MPTSR. For example, if the resource size is not sufficient to report the MPTSR format, including (e.g., consisting of) the buffer information of one or more (e.g., all) parts, the WTRU may report the MPTSR format, including (e.g., consisting of) the buffer for transmission in the first part (e.g., the part for transmission of important control/data).

The WTRU may cancel a pending UCI/MAC CE (e.g., SR/MPTSR).

Upon MPTSR being triggered, the WTRU may keep the MPTSR until it is cancelled. If (e.g., when) MPTSR is not cancelled, the WTRU may keep transmitting the MPTSR if (e.g., when) the WTRU has available resource for transmission of MPTSR report. The WTRU may cancel (e.g., then cancel) MPTSR based on one or any combination of the following: the buffer status of the control/data units triggering the MPTSR is included in the MPTSR report; and/or the control/data units triggering the MPTSR are transmitted in at least a (e.g., one) part of a resource.

The WTRU may be configured for downlink feedback for multi-part uplink transmission. For example, the WTRU may receive feedback for its multi-part transmission.

In one example, the WTRU may transmit (e.g., first transmit) multi bit sequences in a multi-part resource. A (e.g., each) bit sequence may be used to transmit a UCI and/or a TB. The WTRU may be configured with one or more of the following HARQ IDs for the multi-part transmission: a (e.g., one) HARQ ID for a (e.g., each) part of the resource; a (e.g., one) HARQ ID for the whole multi-part transmission; and/or a (e.g., one) HARQ ID for the whole multi-part transmission and an (e.g., one) ID for a (e.g., each) part of the transmission.

The WTRU may be configured with a (e.g., one) HARQ ID for a (e.g., each) part of the resource. For example, the WTRU may be indicated the number of parts associated with HARQ-based transmission. The WTRU may be indicated the first HARQ ID associated with the first part of the multi-part transmission. The HARQ IDs associated with other parts may be the subsequent IDs of the first HARQ ID. The scheduled resource and HARQ ID may be indicated to the WTRU using DCI, MAC-CE, and/or RRC.

For example, the WTRU may be configured with a three-part resource. The WTRU may be indicated the HARQ ID associated with the first part (e.g., HARQ ID #4). The WTRU may consider (e.g., then implicitly consider) the second part, and the third part has HARQ ID #5 and #6, respectively.

The WTRU may be configured with a (e.g., one) HARQ ID for the whole multi-part transmission. For example, the WTRU may be scheduled with a HARQ ID for one or more (e.g., all) parts of the transmission. Upon reception of a retransmission request from the network for the associated HARQ ID, the WTRU may perform (e.g., then perform) retransmission of one or more (e.g., all) parts of the resource. The WTRU may modify the part, which indicates the transmission information of other part. The bit sequence to transmit in this part may be modified based on the transmission information of other parts.

The WTRU may be configured with a (e.g., one) HARQ ID for the whole multi-part transmission and an (e.g., one) ID for a (e.g., each) part of the transmission. For example, the WTRU may be configured to use a (e.g., one) HARQ ID for the whole transmission resource. The WTRU may be (e.g., may also be) indicated the sub-ID associated with a (e.g., each) part.

For example, the WTRU may be indicated a HARQ ID #X for the resource. The WTRU may imply the sub-ID #1, 2, and 3 for the first part, the second part, and the third part, respectively. The WTRU may be indicated to retransmit the bit sequence associated with the HARQ ID #X and the sub-ID.

The WTRU may receive (e.g., then receive) the reception status associated with a (e.g., each) part, one or more parts, and/or all parts of the transmission. In one example, the WTRU may receive the reception status for a multi-part transmission resource by retransmission request from the network (e.g., via DCI scheduling). For example, if the WTRU receives a DCI scheduling the same HARQ ID and potentially associated sub-IDs with NDI not toggled, the WTRU may assume that the associated bit sequence (e.g., the bit sequence with the indicated HARQ ID and sub-ID) may not be received (e.g., be received successfully). The WTRU may retransmit (e.g., then) retransmit the indicated bit sequence. Alternatively and/or additionally, the WTRU may receive the reception status for multi-part resource transmission in a higher layer message, such as MAC-CE and/or RRC. The higher layer message may indicate (e.g., may implicitly/explicitly indicate) which HARQ IDs and associated sub-IDs are ACK/NACK. The WTRU may retransmit (e.g., then retransmit) the bit sequence associated with NACK status. The WTRU may retransmit (e.g., also retransmit) the bit sequence indicated by the network.

The WTRU may determine whether to retransmit a control/data unit transmitted using PHY duplication.

In another example, the WTRU may determine whether to retransmit a control/data unit transmitted using PHY duplication. For example, the WTRU may transmit (e.g., first transmit) a control/data unit in multiple bit sequences of a multi-part resource. The WTRU may receive implicit/explicit HARQ feedback associated with a (e.g., each) bit sequence in a multi-part resource. In one example, the WTRU may determine not to retransmit the control/data unit if it receives ACK feedback in a (e.g., one) of the duplicated parts. This example may be applicable for the case that HARQ combining between the initial and retransmission is not used. In another example, the WTRU may retransmit the bit sequence based on the indication from the network, e.g., regardless of PHY duplication. This example may be motivated to support HARQ combining between initial and retransmissions.

One or more LCP and Tx parameters may be determined for a (e.g., each) part.

The WTRU may receive a configuration(s). In examples, the WTRU may receive the resource for multi-part transmission (e.g., the first part and/or the second part) associated with a scheduled resource for data transmission (e.g., PUSCH). In examples, the WTRU may receive the set of control/data units (e.g., MAC-CE for HARQ feedback, CSI report, high-importance/priority data, and/or the like) that may be transmitted in the second part. In examples, the WTRU may receive the possible formats/sizes of the control/data to be transmitted in the second part.

The WTRU may receive a multi-part (e.g., three-part) grant for uplink transmission, which allows the WTRU to transmit the first, the second, and the third part.

The WTRU may determine and/or perform one or more of the following: the set of associated control/data units to transmit in the second part; and/or the transmission parameters associated with the second part (e.g., MCS, size) based on the QoS of the control/data.

The WTRU may indicate the transmission parameters (e.g., the availability of the second part, the MCS, the resource size, and/or the like) of the second part in the first part.

The WTRU may multiplex the control/data in a TB to be transmitted in the third part.

The WTRU may transmit the TB and/or the determined first and second parts in the scheduled grant.

As described herein, FIG. 2 illustrates an example of the WTRU using the first part to indicate the transmission information about the second part as described herein. FIG. 3 illustrates an example flow diagram (300) illustrating the WTRU using the first part to indicate the transmission information about the second part.

The examples described herein (e.g., as illustrated in FIG. 2 and/or FIG. 3) may enable the WTRU to transmit (e.g., flexibly transmit) the control/data unit (e.g., the important control/data unit) with better protection (e.g., increased reliability compared to the TB transmitted in the grant).

Systems, methods, and instrumentalities are disclosed herein for a multi-part uplink transmission. For example, a device, such as a wireless transmit/receive unit (WTRU), may include a processor, transceiver, and/or memory. The processor, transceiver, and/or memory may be configured to perform one or more of the following.

As illustrated in 305 of FIG. 3, the WTRU may receive configuration information. The configuration information may be, or may include, at least one of: a multi-part resource for a multi-part transmission, at least one set of units associated with the multi-part transmission, or information associated with the at least one set of units. The multi-part transmission may include at least a first part, a second part, and/or the like. In examples, the multi-part transmission may include two parts: a first part and a second part. In examples, the multi-part transmission may include three parts: a first part, a second part, and a third part. In examples, the multi-part transmission may include more than three part transmissions.

The multi-part resource for the multi-part transmission may be associated with a scheduled resource for the multi-part transmission. The at least one set of units may be associated with at least one of the second part of the multi-part transmission or the third part of the multi-part transmission. The information associated with the at least one set of units may be, or may include, at least one of format information for the at least one set of units or size information associated with the at least one set of units.

The at least one set of units described herein may be, or may include, one or more of the following: a control unit, a data unit, a control and data unit, a service data unit (SDU) associated with a protocol layer, a protocol data unit (PDU) associated with a protocol layer, a subset of a PDU set, a PDU set, a multi interdependent PDU set, or a data burst.

As illustrated in 310 of FIG. 3, the WTRU may receive a multi-part grant associated with the multi-part transmission. As described herein, the multi-part transmission may be, or may include, at least two parts (e.g., at least a first part and a second part). In examples, the multi-part transmission may be associated with an uplink transmission. For example, the multi-part transmission may be an uplink transmission.

As illustrated in 315 of FIG. 3, the WTRU may determine that data is available. For example, the WTRU may determine that data is available for the multi-part transmission.

As illustrated in 320 of FIG. 3, based on the configuration information and the determination that data is available, the WTRU may determine at least a first set of units to be transmitted in the second part of the multi-part transmission, a second set of units to be transmitted in a third part of the multi-part transmission, at least one transmission parameter associated with the second part of the multi-part transmission, and/or at least one transmission parameter associated with the third part of the multi-part transmission.

In examples, the at least one transmission parameter associated with the second part of the multi-part transmission and the at least one transmission parameter associated with the third part of the multi-part transmission may be, or may include, one or more of the following: a modulation and/or coding (MCS), a resource size, or a number of bits in a bit-sequence to transmit the second part of the multi-part transmission, a channel format, a demodulation reference signal (DMRS) pattern, a relative transmission power, an applicable transmission power offset, an applicable maximum power reduction (MPR), an applicable set of power control parameters, an applicable transmission configuration indicator (TCI) state, or a beam associated with the second part of the multi-part transmission.

In examples, the WTRU may determine the at least one transmission parameter associated with the second part of the multi-part transmission based on a quality of service (QoS) associated with the first set of units. In examples, the WTRU may determine the at least one transmission parameter associated with the third part of the multi-part transmission based on a QoS associated with the second set of units.

As illustrated in 325 of FIG. 3, the WTRU may indicate the at least one transmission parameter associated with the second part of the multi-part transmission in the first part of the multi-part transmission or the at least one transmission parameter associated with the third part of the multi-part transmission in the first part of the multi-part transmission. For example, the WTRU may determine at least one transmission parameter associated with the second part of the multi-part transmission in the first part of the multi-part transmission or the at least one transmission parameter associated with the third part of the multi-part transmission in the first part of the multi-part transmission. As described herein, the WTRU may perform the multi-part transmission that includes the determined at least one transmission parameter associated with the second part of the multi-part transmission in the first part of the multi-part transmission or the at least one transmission parameter associated with the third part of the multi-part transmission in the first part of the multi-part transmission.

In examples, the first part of the multi-part transmission may be associated with a transmission of an uplink control information (UCI) format to indicate transmission information associated with at least one of the second part or the third part of the multi-part transmission.

As illustrated in 330 of FIG. 3, the WTRU may multiplex at least one of the first set of units in a first transport block (TB) or the second set of units in a second TB, wherein the first TB is to be transmitted in the second part of the multi-part transmission, and wherein the second TB is to be transmitted in the third part of the multi-part transmission.

The first TB may be associated with a transmission of a medium access control (MAC) control element (CE). For example, the MAC-CE may be, or may include, at least one of hybrid automatic repeat request (HARQ) Acknowledgement (ACK), HARQ Negative ACK (NACK), or Channel State Information (CSI) reporting. The second TB may be associated with a data transmission (e.g., data associated with prior transmission).

As illustrated in 335 of FIG. 3, the WTRU may perform the multi-part transmission associated with the multi-part grant. For example, the WTRU may transmit at least one of the first TB that is associated with the second part of the multi-part transmission or the second TB that is associated with the third part of the multi-part transmission. The WTRU may also transmit the first part of the multi-part transmission.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU) comprising:
a processor configured to:
receive configuration information, wherein the configuration information comprises at least one of: a multi-part resource for a multi-part transmission, at least one set of units associated with the multi-part transmission, or information associated with the at least one set of units;
receive a multi-part grant associated with the multi-part transmission, wherein the multi-part transmission comprises at least a first part and a second part;
determine that data is available;
based on the configuration information and the determination that data is available, determine at least a first set of units to be transmitted in the second part of the multi-part transmission, a second set of units to be transmitted in a third part of the multi-part transmission, at least one transmission parameter associated with the second part of the multi-part transmission, or at least one transmission parameter associated with the third part of the multi-part transmission;
indicate the at least one transmission parameter associated with the second part of the multi-part transmission in the first part of the multi-part transmission or the at least one transmission parameter associated with the third part of the multi-part transmission in the first part of the multi-part transmission;
multiplex at least one of the first set of units in a first transport block (TB) or the second set of units in a second TB, wherein the first TB is to be transmitted in the second part of the multi-part transmission, and wherein the second TB is to be transmitted in the third part of the multi-part transmission; and
perform the multi-part transmission associated with the multi-part grant.

2. The WTRU of claim 1, wherein the multi-part resource for the multi-part transmission is associated with a scheduled resource for the multi-part transmission, wherein the at least one set of units is associated with at least one of the second part of the multi-part transmission or the third part of the multi-part transmission, and wherein the information associated with the at least one set of units comprises at least one of format information for the at least one set of units or size information associated with the at least one set of units.

3. The WTRU of claim 1, wherein the at least one transmission parameter associated with the second part of the multi-part transmission and the at least one transmission parameter associated with the third part of the multi-part transmission comprise at least one of a modulation and/or coding (MCS), a resource size, or a number of bits in a bit-sequence to transmit the second part of the multi-part transmission, a channel format, a demodulation reference signal (DMRS) pattern, a relative transmission power, an applicable transmission power offset, an applicable maximum power reduction (MPR), an applicable set of power control parameters, an applicable transmission configuration indicator (TCI) state, or a beam associated with the second part of the multi-part transmission.

4. The WTRU of claim 1, wherein the first part of the multi-part transmission is associated with a transmission of an uplink control information (UCI) format to indicate transmission information associated with at least one of the second part or the third part of the multi-part transmission.

5. The WTRU of claim 1, wherein the first TB is associated with a transmission of a medium access control (MAC) control element (CE), wherein the MAC-CE comprises at least one of hybrid automatic repeat request (HARQ) Acknowledgement (ACK), HARQ Negative ACK (NACK), or Channel State Information (CSI) reporting, and wherein the second TB is associated with a data transmission.

6. The WTRU of claim 1, wherein the at least one set of unit comprises at least one of a control unit, a data unit, a control and data unit, a service data unit (SDU) associated with a protocol layer, a protocol data unit (PDU) associated with a protocol layer, a subset of a PDU set, a PDU set, a multi interdependent PDU set, or a data burst.

7. The WTRU of claim 1, wherein the at least one transmission parameter associated with the second part of the multi-part transmission is determined based on a quality of service (QoS) associated with the first set of units and the at least one transmission parameter associated with the third part of the multi-part transmission is determined based on a QoS associated with the second set of units.

8. A method comprising:
receiving configuration information, wherein the configuration information comprises at least one of: a multi-part resource for a multi-part transmission, at least one set of units associated with the multi-part transmission, or information associated with the at least one set of units;
receiving a multi-part grant associated with the multi-part transmission, wherein the multi-part transmission comprises at least a first part and a second part;
determining that data is available;
based on the configuration information and the determination that data is available, determining at least a first set of units to be transmitted in the second part of the multi-part transmission, a second set of units to be transmitted in a third part of the multi-part transmission, at least one transmission parameter associated with the second part of the multi-part transmission, or at least one transmission parameter associated with the third part of the multi-part transmission;
indicating the at least one transmission parameter associated with the second part of the multi-part transmission in the first part of the multi-part transmission or the at least one transmission parameter associated with the third part of the multi-part transmission in the first part of the multi-part transmission;
multiplexing at least one of the first set of units in a first transport block (TB) or the second set of units in a second TB, wherein the first TB is to be transmitted in the second part of the multi-part transmission, and wherein the second TB is to be transmitted in the third part of the multi-part transmission; and
performing the multi-part transmission associated with the multi-part grant.

9. The method of claim 8, wherein the multi-part resource for the multi-part transmission is associated with a scheduled resource for the multi-part transmission, wherein the at least one set of units is associated with at least one of the second part of the multi-part transmission or the third part of the multi-part transmission, and wherein the information associated with the at least one set of units comprises at least one of format information for the at least one set of units or size information associated with the at least one set of units.

10. The method of claim 8, wherein the at least one transmission parameter associated with the second part of the multi-part transmission and the at least one transmission parameter associated with the third part of the multi-part transmission comprise at least one of a modulation and/or coding (MCS), a resource size, or a number of bits in a bit-sequence to transmit the second part of the multi-part transmission, a channel format, a demodulation reference signal (DMRS) pattern, a relative transmission power, an applicable transmission power offset, an applicable maximum power reduction (MPR), an applicable set of power control parameters, an applicable transmission configuration indicator (TCI) state, or a beam associated with the second part of the multi-part transmission.

11. The method of claim 8, wherein the first part of the multi-part transmission is associated with a transmission of an uplink control information (UCI) format to indicate transmission information associated with at least one of the second part or the third part of the multi-part transmission.

12. The method of claim 8, wherein the first TB is associated with a transmission of a medium access control (MAC) control element (CE), wherein the MAC-CE comprises at least one of hybrid automatic repeat request (HARQ) Acknowledgement (ACK), HARQ Negative ACK (NACK), or Channel State Information (CSI) reporting, and wherein the second TB is associated with a data transmission.

13. The method of claim 8, wherein the at least one set of unit comprises at least one of a control unit, a data unit, a control and data unit, a service data unit (SDU) associated with a protocol layer, a protocol data unit (PDU) associated with a protocol layer, a subset of a PDU set, a PDU set, a multi interdependent PDU set, or a data burst.

14. The method of claim 8, wherein the at least one transmission parameter associated with the second part of the multi-part transmission is determined based on a quality of service (QoS) associated with the first set of units and the at least one transmission parameter associated with the third part of the multi-part transmission is determined based on a QoS associated with the second set of units.
